(19) United States
(12) Patent Application Publication
(10) Pub. No.: US 2023/0235470 A1
(43) Pub. Date: Jul. 27, 2023

(54) APPARATUS FOR ELECTROREFINING A FERROUS MOLTEN METAL AND METHOD ASSOCIATED THEREWITH

(71) Applicants: THE GOVERNING COUNCIL OF THE UNIVERSITY OF TORONTO, Toronto (CA); TENOVA GOODFELLOW INC., Mississauga, CA (US)

(72) Inventors: GISELE AZIMI, Toronto (CA); WILLIAM D. JUDGE, Toronto (CA); SCIPOLO VITTORIO, Etobicoke (CA)

(73) Assignees: THE GOVERNING COUNCIL OF THE UNIVERSITY OF TORONTO, Toronto, ON (CA); TENOVA GOODFELLOW INC., Mississauga, ON (CA)

(21) Appl. No.: 17/918,938

(22) PCT Filed: Apr. 16, 2020
(86) PCT No.: PCT/CA2020/050504

§ 371 Date: Oct. 14, 2022

(51) Int. Cl. C25C 3/34; C25C 7/02; C25C 7/00; C21C 1/00; C25C 7/06

(52) U.S. Cl. CPC C25C 3/34; C25C 7/025; C25C 7/005; C21C 1/00; C25C 7/06

(57) ABSTRACT

Electrorefining cells and methods for electrorefining ferrous molten metal (e.g. steels), that includes impurities (e.g., carbon), are described. Liquid metal is provided in ladle with a molten electrolyte on top of it to form a metal-electrolyte interface. An electrode connection is put into contact with the metal for electronic conduction therewith, while a counter electrode is put into contact with the electrolyte for forming an electrolyte-counter electrode interface. Both the electrode connection and the counter electrode remain in the solid form in, and inert to, the metal and the electrolyte, respectively. The electrode connection and the counter electrode are made of an electronically conductive material. Therefore, during electrorefining operations, an electromotive force can be supplied between the electrode connection and the counter electrode so as to induce electrochemical reactions to occur at both the metal-electrolyte interface and the electrolyte-counter electrode connection, producing a ferrous molten metal depleted of the impurities.

### TECHNICAL FIELD

The present disclosure generally relates to apparatuses and methods for electrorefining metals. More particularly, the present disclosure relates to apparatuses and methods for electrorefining molten metals that include iron and impurities.

### BACKGROUND

Steelmaking is a trillion-dollar per year industry with some 1.8 billion tonnes of steel produced in 2019. Demand for steel (less than 2% carbon) continues to increase as it is closely intertwined with economic growth, providing the basic material for high value products in construction, transportation, energy, utilities, and consumer sectors. Despite continued growth of the industry, steelmakers are facing considerable challenges emerging such as increasingly stringent emissions targets, increased energy costs, and lower quality feed materials. At the same time, the demand for higher quality steels with lower levels of impurities, such as carbon, sulfur, oxygen, phosphorus and the like, is increasing. In particular, carbon should be minimized in stainless steels to improve performance, while some ultra-low carbon steels require carbon contents below 20 to 30 ppm, for example.

Typically, steel is produced using hot metal from blast furnaces, direct reduced iron, recycled scrap, or some combination thereof. Transforming raw materials to high value products, such as stainless steels or ultra-low carbon steels, requires treatments in several reactors. Refinement via argon-oxygen decarburization, vacuum oxygen decarburization, recirculation degassing, etc. is required to remove impurities such as carbon so as to reach such low levels of carbon contents and minimize oxidation of iron and chromium. While these technologies produce the required grades of steel, they are batch processes, consume reagents, lose metal to the slag, operate with corrosive slags, and have complicated process control. All these drawbacks reduce productivity and increase costs.

There is therefore a need to develop apparatuses and methods that are capable of refining high purity ferrous metals with high throughput and low capital and operating expenditures.

### SUMMARY

In one implementation, there is provided a method for electrorefining a ferrous molten metal that includes iron and impurities, the method comprising: providing the ferrous molten metal to be refined in a treatment ladle with a molten electrolyte on top of the ferrous molten metal so as to form a metal-electrolyte interface; contacting an electrode connection made of a first electronically conductive material remaining in a solid form in, and being substantially inert to, the ferrous molten metal with the ferrous molten metal for electronic conduction therewith; contacting a counter electrode made of a second electronically conductive material remaining in a solid form in, and being substantially inert to, the molten electrolyte with the molten electrolyte so as to form an electrolyte-counter electrode interface; and during electrorefining operations: supplying an electromotive force between the electrode connection and the counter electrode so as to induce electrochemical reactions to occur at both the metal-electrolyte interface and the electrolyte-counter electrode interface; and producing a ferrous molten metal depleted of the impurities.

In one implementation, a reaction by-product is recovered at the counter electrode during the electrorefining operations.

In one implementation, the impurities comprise carbon.

In one implementation, the impurities comprise copper.

In one implementation, the impurities comprise sulfur.

In one implementation, the impurities comprise oxygen.

In one implementation, the impurities comprise phosphorus.

In one implementation, the ferrous molten metal comprises molten steel.

In one implementation, the ferrous molten metal comprises a molten iron-alloy.

In one implementation, the reaction by-product comprises silicon.

In one implementation, the reaction by-product comprises ferrosilicon.

In one implementation, the reaction by-product comprises aluminum.

In one implementation, the impurities content of the ferrous molten metal prior to the electrorefining operations is between about 0.01% and about 10%, between about 0.05% and about 5%, or between about 0.1% and about 1%.

In one implementation, the impurities content of the ferrous molten metal prior to the electrorefining operations is between about 40 ppmw and about 100 ppmw, between about 50 ppmw and about 90 ppmw, or between about 60 ppmw and about 80 ppmw.

In one implementation, the impurities content of the ferrous molten metal depleted of the impurities after the electrorefining operations have been performed is below about 100 ppmw, below about 75 ppmw, below about 50 ppmw or below about 10 ppmw.

In one implementation, the connection material has a melting temperature higher than about 1600° C., higher than about 1700° C., or higher than about 1800° C.

In one implementation, the first electronically conductive material is an electronically conducting ceramic.

In one implementation, the first electronically conductive material comprises a refractory metal boride.

In one implementation, the first electronically conductive material comprises zirconium diboride (ZrB₂).

In one implementation, the first electronically conductive material comprises titanium diboride (TiB₂).

In one implementation, the first electronically conductive material comprises hafnium diboride (HfB₂).

In one implementation, the first electronically conductive material comprises tantalum diboride (TaB₂).

In one implementation, the first electronically conductive material comprises niobium diboride (NbB₂).

In one implementation, the first electronically conductive material comprises vanadium diboride (VB₂).

In one implementation, the first electronically conductive material comprises chromium boride (CrB).

In one implementation, the first electronically conductive material comprises chromium diboride (CrB₂).

In one implementation, the first electronically conductive material comprises a molybdenum boride.

In one implementation, the first electronically conductive material comprises a tungsten boride.

In one implementation, the first electronically conductive material comprises between about 40% v/v and about 100% v/v, between about 50% v/v and about 95% v/v, or between about 60% v/v and about 90% v/v of zirconium diboride.

In one implementation, the first electronically conductive material comprises between about 40% v/v and about 100% v/v, between about 50% v/v and about 95% v/v, or between about 60% v/v and about 90% v/v of titanium diboride.

In one implementation, the first electronically conductive material comprises between about 40% v/v and about 100% v/v, between about 50% v/v and about 95% v/v, or between about 60% v/v and about 90% v/v of hafnium diboride.

In one implementation, the first electronically conductive material comprises between about 40% v/v and about 100% v/v, between about 50% v/v and about 95% v/v, or between about 60% v/v and about 90% v/v of tantalum diboride.

In one implementation, the first electronically conductive material comprises between about 40% v/v and about 100% v/v, between about 50% v/v and about 95% v/v, or between about 60% v/v and about 90% v/v of niobium diboride.

In one implementation, the first electronically conductive material comprises between about 40% v/v and about 100% v/v, between about 50% v/v and about 95% v/v, or between about 60% v/v and about 90% v/v of vanadium diboride.

In one implementation, the electronically conductive material comprises between about 40% v/v and about 100% v/v, between about 50% v/v and about 95% v/v, or between about 60% v/v and about 90% v/v of chromium boride.

In one implementation, the first electronically conductive material comprises between about 40% v/v and about 100% v/v, between about 50% v/v and about 95% v/v, or between about 60% v/v and about 90% v/v of chromium diboride.

In one implementation, the first electronically conductive material comprises between about 40% v/v and about 100% v/v, between about 50% v/v and about 95% v/v, or between about 60% v/v and about 90% v/v of the molybdenum boride.

In one implementation, the first electronically conductive material comprises between about 40% v/v and about 100% v/v, between about 50% v/v and about 95% v/v, or between about 60% v/v and about 90% v/v of the tungsten boride.

In one implementation, the method comprises submerging the electrode connection into the ferrous molten metal for electronic conduction therewith.

In one implementation, the method comprises protecting the electrode connection from the ferrous molten metal using a protective sheath.

In one implementation, the method comprises providing the electrode connection to extend from the treatment ladle.

In one implementation, the method comprises contacting a plurality of electrode connections with the ferrous molten metal for electronic conduction therewith.

In one implementation, the electrode connection is positioned opposite to the metal-electrolyte interface.

In one implementation, the method comprises promoting electro-vortex mixing of the ferrous molten metal.

In one implementation, the second electronically conductive material has a melting temperature higher than about 1600° C., or higher than about 1700° C.

In one implementation, the second electronically conductive material has a melting temperature higher than about 1800° C.

In one implementation, the second electronically conductive material is resistant to an oxidative atmosphere.

In one implementation, the second electronically conductive material is inert to the reaction by-product.

In one implementation, the second electronically conductive material comprises molybdenum (Mo), graphite (C), carbon (C), tantalum (Ta), niobium (Nb), chromium (Cr), a platinum group metal, a refractory metal boride(s), zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof.

In one implementation, the counter electrode comprises between about 40% v/v and about 100% v/v, between about 50% v/v and about 95% v/v, or between about 60% v/v and about 90% v/v of the second electronically conductive material.

In one implementation, the method comprises submerging the counter electrode into the molten electrolyte.

In one implementation, an alloy is formed with the counter electrode and the reaction by-product.

In one implementation, the method comprises protecting the counter electrode from the molten electrolyte.

In one implementation, the protection is provided by a protective sheath made of a ceramic material.

In one implementation, the protection is provided by a protective sheath made of a material comprising graphite.

In one implementation, the method comprises providing the counter electrode to extend from the treatment ladle so as to be in contact with the molten electrolyte.

In one implementation, the method comprises contacting a plurality of counter electrodes with the molten electrolyte for forming the electrolyte-counter electrode interface.

In one implementation, the method comprises positioning the counter electrode opposite to the metal-electrolyte interface.

In one implementation, the method comprises collecting the reaction by-product at a by-product collection area of the counter electrode facing the metal-electrolyte interface.

In one implementation, the impurities and the molten electrolyte have a chemical affinity.

In one implementation, the molten electrolyte has a melting temperature higher than about 1300° C., higher than about 1400° C., or higher than about 1500° C.

In one implementation, the molten electrolyte and the reaction by-product have a chemical affinity.

In one implementation, the molten electrolyte has a density lower than the density of the ferrous molten metal.

In one implementation, the molten electrolyte has a density higher than the density of the reaction by-product.

In one implementation, the molten electrolyte has a density of between about 2 g/cm³ and about 7 g/cm³, of between about 2.2 g/cm³ and about 6 g/cm³, or of between about 2.5 g/cm³ and about 5.5 g/cm³.

In one implementation, the molten electrolyte has a viscosity of between about 0.1 poise and about 5 poise, between about 0.5 poise and about 4 poise, or between about 1 poise and about 3 poise.

In one implementation, the molten electrolyte has a vapour pressure below about 0.01 atm, below about 0.001 atm, or below 0.0001 atm.

In one implementation, the counter electrode is provided at a distance from the metal-electrolyte interface.

In one implementation, the distance is between about 1 cm and about 50 cm, between about 2 cm and about 20 cm, or between about 2 cm and about 10 cm.

In one implementation, the thickness of the ferrous molten metal is between about 2 cm and about 300 cm, between about 10 cm and about 200 cm, or between about 50 cm and about 150 cm.

In one implementation, the thickness of the molten electrolyte is between about 2 cm and about 200 cm, between about 5 cm and about 100 cm, or between about 5 cm and about 50 cm.

In one implementation, the thickness of the molten electrolyte is between about 1% and about 30%, between about 4% and about 20%, or between about 5% and about 15% the thickness of the ferrous molten metal.

In one implementation, the molten electrolyte is an ionic conductor for allowing flow of ions therethrough.

In one implementation, the molten electrolyte comprises an oxide.

In one implementation, the oxide comprises calcium oxide (CaO).

In one implementation, the oxide comprises aluminium oxide (Al₂O₃).

In one implementation, the oxide comprises silicon dioxide (SiO₂).

In one implementation, the oxide comprises magnesium oxide (MgO).

In one implementation, the molten electrolyte comprises a sulfide.

In one implementation, the molten electrolyte comprises a chloride.

In one implementation, the molten electrolyte further comprises a fluoride.

In one implementation, the molten electrolyte is a slag formed on top of the ferrous molten metal.

In one implementation, the method comprises providing one of: a current or a potential to the electrode connection and the counter electrode to be modulated at the metal-electrolyte interface.

In one implementation, the method comprises modulating potential to supply the electromotive force between the electrode connection and the counter electrode.

In one implementation, the potential is direct potential.

In one implementation, the potential is alternating potential.

In one implementation, the potential is a combination of direct potential and alternating potential.

In one implementation, the method comprises modulating current to supply the electromotive force between the electrode connection and the counter electrode.

In one implementation, the current is direct current.

In one implementation, the current is alternating current.

In one implementation, the current is a combination of direct current and alternating current.

In one implementation, the potential is between about 0.01 V and about 30 V, between about 0.1 V and about 10 V, or between about 0.5 V and about 5 V.

In one implementation, the current is between about 1 mA/cm² and about 5000 mA/cm², between about 10 mA/cm² and about 1000 mA/cm², or between about 50 mA/cm² and about 500 mA/cm².

In one implementation, the method comprises contacting an auxiliary electrode made of a third electronically conductive material with the molten electrolyte for electrochemically measuring the impurities content.

In one implementation, the auxiliary electrode is submerged into the molten electrode to form an electrolyte-auxiliary electrode interface.

In one implementation, the third electronically conductive material is inert to the molten electrolyte.

In one implementation, the third electronically conductive material remains in a solid form in the molten electrolyte.

In one implementation, the third electronically conductive material comprises molybdenum (Mo), graphite (C), carbon (C), tantalum (Ta), niobium (Nb), chromium (Cr), a platinum group metal, a refractory metal boride(s), zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof.

In one implementation, the auxiliary electrode is a reference electrode with a determined thermodynamic electrode potential.

In one implementation, the method comprises contacting a plurality of auxiliary electrodes with the molten electrolyte.

In one implementation, the impurities are selectively reacted and removed from the ferrous molten metal to produce the ferrous molten metal depleted of the impurities.

In one implementation, the electromotive force is supplied to the electrode connection and the counter electrode for a retention time sufficient to reduce the impurities content.

In one implementation, the retention time is between about 0.1 hour and about 10 hours, between about 0.5 hour and about 5 hours, or between about 0.5 hour and about 2 hours.

In one implementation, the method comprises monitoring sensitive electrochemical signals of at least one of: the ferrous molten metal or the molten electrolyte during the electrorefining operations.

In one implementation, the electrochemical signals are determined by at least one of: potential, polarization characteristics, or impedance spectroscopy.

In one implementation, the method comprises adjusting the electromotive force relative to the electrochemical signals monitored.

In one implementation, adjusting the electromotive force is performed in real time.

In one implementation, the method comprises adjusting the electromotive force relative to the impurities content of the ferrous molten metal.

In one implementation, the method comprises adjusting the electromotive force relative to the reaction by-product content of the molten electrolyte.

In one implementation, the electromotive force is supplied relative to the composition of the ferrous molten metal.

In one implementation, the electromotive force is supplied relative to the composition of the impurities.

In one implementation, the electromotive force is supplied relative to a stage of the electrorefining operations.

In one implementation, the electromotive force is supplied relative to the temperature of the ferrous molten metal.

In one implementation, the method comprises electrochemically recovering ferrous molten metal products transferred to the molten electrolyte during the electrorefining operations.

In one implementation, the recovering is performed for the ferrous molten metal that has been oxidized inadvertently during the electrorefining operations.

In one implementation, the recovering is performed for the ferrous molten metal that has been dispersed as droplets or as an emulsion through the molten electrolyte during the electrorefining operations.

In one implementation, energy consumed during the electrorefining operations is between about 1 kWh/kg of impurities and about 50 kWh/kg of impurities, between about 5 kWh/kg of impurities and about 40 kWh/kg of impurities, or between about 10 kWh/kg of impurities and about 20 kWh/kg of impurities.

In one implementation, the energy consumed during the electrorefining operations is between about 1 kWh/kg of carbon and about 50 kWh/kg of carbon, between about 5 kWh/kg of carbon and about 40 kWh/kg of carbon, or between about 10 kWh/kg of carbon and about 20 kWh/kg of carbon.

In one implementation, the energy consumed during the electrorefining operations is between about 1 kWh/t of ferrous molten metal and about 2000 kWh/t of ferrous molten metal, between about 100 kWh/t of ferrous molten metal and about 1500 kWh/t of ferrous molten metal, or between about 500 kWh/t of ferrous molten metal and about 1000 kWh/t of ferrous molten metal.

In one implementation, the energy consumed during the electrorefining operations is between about 1 kWh/t of molten steel and about 2000 kWh/t of molten steel, between about 100 kWh/t of molten steel and about 1500 kWh/t of molten steel, or between about 500 kWh/t of molten steel and about 1000 kWh/t of molten steel.

In one implementation, the electrorefining operations are operated so that the impurities content of the ferrous molten metal depleted of the impurities is between about 0.01% and about 80%, between about 0.1% and about 50%, or between about 1% and about 10% the impurities content of the ferrous molten metal.

In one implementation, the electrorefining operations are operated so that the impurities content of the ferrous molten metal depleted of the impurities is below a threshold so as to be suitable for the production of an ultra-low carbon steel.

In one implementation, the electrorefining operations are operated so that the impurities content of the ferrous molten metal depleted of the impurities is below a threshold so as to be suitable for the production of a stainless steel.

In one implementation, the electrorefining operations are performed under an oxidizing atmosphere.

In one implementation, the electrorefining operations are performed under an inert atmosphere.

In one implementation, the electrorefining operations are performed under a vacuum atmosphere.

In one implementation, the impurities content is sensed or measured electrochemically.

In one implementation, there is provided an apparatus for electrorefining a ferrous molten metal that includes iron and impurities, the ferrous molten metal being contained in a treatment ladle and being covered by a molten electrolyte so as to form a metal-electrolyte interface, the apparatus comprising: an electrode connection made of a first electronically conductive material remaining in a solid form in, and being substantially inert to, the ferrous molten metal, to be in contact with the ferrous molten metal for electronic conduction therewith; a counter electrode made of a second electronically conductive material remaining in a solid form in, and being substantially inert to, the molten electrolyte, to be in contact with the molten electrolyte for forming an electrolyte-counter electrode interface; a power supply in electrical communication with both the electrode connection and the counter electrode for imposing an electromotive force between the electrode connection and the counter electrode so as to induce electrochemical reactions to occur at both the metal-electrolyte interface and the electrolyte-counter electrode interface, thereby producing a ferrous molten metal depleted of the impurities.

In one implementation, the impurities comprise carbon.

In one implementation, the impurities comprise copper.

In one implementation, the impurities comprise sulfur.

In one implementation, the impurities comprise oxygen.

In one implementation, the impurities comprise phosphorus.

In one implementation, the ferrous molten metal comprises molten steel.

In one implementation, the ferrous molten metal comprises a molten iron-alloy.

In one implementation, the first electronically conductive material has a melting temperature higher than about 1600° C., higher than about 1700° C., or higher than about 1800° C.

In one implementation, the first electronically conductive material is an electronically conducting ceramic.

In one implementation, the first electronically conductive material comprises a refractory metal boride.

In one implementation, the first electronically conductive material comprises zirconium diboride (ZrB₂).

In one implementation, the first electronically conductive material comprises titanium diboride (TiB₂).

In one implementation, the first electronically conductive material comprises hafnium diboride (HfB₂).

In one implementation, the first electronically conductive material comprises tantalum diboride (TaB₂).

In one implementation, the first electronically conductive material comprises niobium diboride (NbB₂).

In one implementation, the first electronically conductive material comprises vanadium diboride (VB₂).

In one implementation, the first electronically conductive material comprises chromium boride (CrB).

In one implementation, the first electronically conductive material comprises chromium diboride (CrB₂).

In one implementation, the first electronically conductive material comprises a molybdenum boride.

In one implementation, the first electronically conductive material comprises a tungsten boride.

In one implementation, the first electronically conductive material comprises between about 40% v/v and about 100% v/v, between about 50% v/v and about 95% v/v, or between about 60% v/v and about 90% v/v of zirconium diboride.

In one implementation, the first electronically conductive material comprises between about 40% v/v and about 100% v/v, between about 50% v/v and about 95% v/v, or between about 60% v/v and about 90% v/v of titanium diboride.

In one implementation, the first electronically conductive material comprises between about 40% v/v and about 100% v/v, between about 50% v/v and about 95% v/v, or between about 60% v/v and about 90% v/v of hafnium diboride.

In one implementation, the first electronically conductive material comprises between about 40% v/v and about 100% v/v, between about 50% v/v and about 95% v/v, or between about 60% v/v and about 90% v/v of tantalum diboride.

In one implementation, the first electronically conductive material comprises between about 40% v/v and about 100% v/v, between about 50% v/v and about 95% v/v, or between about 60% v/v and about 90% v/v of niobium diboride.

In one implementation, the first electronically conductive material comprises between about 40% v/v and about 100% v/v, between about 50% v/v and about 95% v/v, or between about 60% v/v and about 90% v/v of vanadium diboride.

In one implementation, the first electronically conductive material comprises between about 40% v/v and about 100% v/v, between about 50% v/v and about 95% v/v, or between about 60% v/v and about 90% v/v of chromium boride.

In one implementation, the first electronically conductive material comprises between about 40% v/v and about 100% v/v, between about 50% v/v and about 95% v/v, or between about 60% v/v and about 90% v/v of chromium diboride.

In one implementation, the first electronically conductive material comprises between about 40% v/v and about 100% v/v, between about 50% v/v and about 95% v/v, or between about 60% v/v and about 90% v/v of the molybdenum boride.

In one implementation, the first electronically conductive material comprises between about 40% v/v and about 100% v/v, between about 50% v/v and about 95% v/v, or between about 60% v/v and about 90% v/v of the tungsten boride.

In one implementation, the first electronically conductive material is configured to be submerged into the ferrous molten metal for electronic conduction therewith.

In one implementation, the apparatus comprises an electrode connection wire electrically connecting the electrode connection to the power supply.

In one implementation, the apparatus comprises a protective sheath for receiving the electrode connection and the electrode connection wire therein.

In one implementation, the treatment ladle comprises a bottom and a peripheral wall upwardly extending therefrom, the electrode connection extending from at least one of: the bottom or the peripheral wall of the treatment ladle.

In one implementation, the apparatus comprises a plurality of electrode connections configured to be in contact with the ferrous molten metal for electronic conduction therewith.

In one implementation, the electrode connection is positioned opposite to the metal-electrolyte interface.

In one implementation, the surface area of the electrode connection is less than the surface area of the metal-electrolyte interface to promote electro-vortex mixing of the ferrous molten metal.

In one implementation, the surface area of the electrode connection is between about 0.1% and about 95%, between about 0.5% and about 85%, or between about 1% and about 70% the surface area of the metal-electrolyte interface.

In one implementation, the second electronically conductive material has a melting temperature higher than about 1600° C., or higher than about 1700° C.

In one implementation, the second electronically conductive material has a melting temperature higher than about 1800° C.

In one implementation, the second electronically conductive material is resistant to an oxidative atmosphere.

In one implementation, a reaction by-product is formed at the counter electrode, the second electronically conductive material being substantially inert to the reaction by-product.

In one implementation, the second electronically conductive material comprises molybdenum (Mo), graphite (C), carbon (C), tantalum (Ta), niobium (Nb), chromium (Cr), a platinum group metal, a refractory metal boride(s), zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof.

In one implementation, the counter electrode comprises between about 40% v/v and about 100% v/v, between about 50% v/v and about 95% v/v, or between about 60% v/v and about 90% v/v of the second electronically conductive material.

In one implementation, the counter electrode is configured to be submerged into the molten electrolyte.

In one implementation, the surface area of the counter electrode is between about 10% and about 200%, between about 20% and about 100%, or between about 30% and about 80% the surface area of the metal-electrolyte interface.

In one implementation, the apparatus comprises a counter electrode wire electrically connecting the counter electrode to the power supply.

In one implementation, the apparatus comprises a protective sheath for receiving the counter electrode and the counter electrode wire therein.

In one implementation, the protective sheath is made of a ceramic material.

In one implementation, the protective sheath is made of a material comprising graphite.

In one implementation, the counter electrode extends from the treatment ladle so as to be in contact with the molten electrolyte.

In one implementation, the apparatus comprises a plurality of counter electrodes configured to be in contact with the molten electrolyte.

In one implementation, the counter electrode is positioned opposite to the metal-electrolyte interface.

In one implementation, the counter electrode is configured to collect the reaction by-product.

In one implementation, the counter electrode comprises a by-product collection area facing the metal-electrolyte interface to collect the reaction by-product produced during the electrorefining operations.

In one implementation, the counter electrode is located at a distance from the metal-electrolyte interface.

In one implementation, the distance is between about 1 cm and about 30 cm, between about 2 cm and about 20 cm, or between about 5 cm and about 10 cm.

In one implementation, the power supply is configured to provide one of: a current or a potential to be modulated at the metal-electrolyte interface.

In one implementation, the power supply is configured to modulate potential.

In one implementation, the potential is direct potential.

In one implementation, the potential is alternating potential.

In one implementation, the potential is a combination of direct potential and alternating potential.

In one implementation, the power supply is configured to modulate current.

In one implementation, the current is direct current.

In one implementation, the current is alternating current.

In one implementation, the current is a combination of direct current and alternating current.

In one implementation, the apparatus comprises an auxiliary electrode made of a third electronically conductive material configured to be in contact with the molten electrolyte for electrochemically measuring the impurities content of the ferrous molten metal.

In one implementation, the auxiliary electrode is configured to be submerged into the molten electrode.

In one implementation, the third electronically conductive material remains in a solid form in, and being substantially inert to, the molten electrolyte.

In one implementation, the third electronically conductive material comprises molybdenum (Mo), graphite (C), carbon (C), tantalum (Ta), niobium (Nb), chromium (Cr), a platinum group metal, a refractory metal boride(s), zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof.

In one implementation, the apparatus comprises a plurality of auxiliary electrodes.

In one implementation, there is provided a method for electrorefining a ferrous molten metal that includes iron and impurities, the method comprising: providing the ferrous molten metal to be refined in a treatment ladle with an electrolyte in contact with the ferrous molten metal so as to form a metal-electrolyte interface; contacting an electrode connection made of a first electronically conductive material remaining in a solid form in, and being substantially inert to, the ferrous molten metal with the ferrous molten metal for electronic conduction therewith; contacting a counter electrode made of second electronically conductive material remaining in a solid form in, and being substantially inert to, the electrolyte with the electrolyte for forming an electrolyte-counter electrode interface; and during electrorefining operations: supplying an electromotive force between the electrode connection and the counter electrode so as to induce electrochemical reactions to occur at both the metal-electrolyte interface and the electrolyte-counter electrode interface; and producing a ferrous molten metal depleted of the impurities.

In one implementation, the electrolyte is provided in a molten form on top of the ferrous molten metal.

In one implementation, the molten electrolyte is a slag formed on top of the ferrous molten metal.

In one implementation, the counter electrode is submerged, at least in part, in the molten electrolyte.

In one implementation, the electrolyte is provided in a solid form.

In one implementation, the method comprises displacing the solid electrolyte in the molten electrolyte during the electrorefining operations to collect the impurities.

In one implementation, there is provided a method for electrorefining a molten steel that includes carbon impurities, the method comprising: providing the molten steel to be refined in a treatment ladle with an ionic slag formed on top of the molten steel so as to form a steel-slag interface; contacting an electrode connection made of a first electronically conductive material remaining in a solid form in, and being substantially inert to, the molten steel with the molten steel for electronic conduction therewith; contacting a counter electrode made of a second electronically conductive material remaining in a solid form in, and being substantially inert to, the slag with the slag for forming a slag-counter electrode interface; and during electrorefining operations: supplying an electromotive force between the electrode connection and the counter electrode so as to induce electrochemical reactions to occur at both the steel-slag interface and the slag-counter electrode interface; and producing a molten steel depleted of the carbon impurities.

In one implementation, a silicon by-product is recovered at the counter electrode during the refining operations.

### BRIEF DESCRIPTION OF THE DRAWINGS

FIG. 1A is an elevation cross-sectional schematic view of an apparatus for electrorefining a ferrous molten metal that includes iron and impurities in accordance with one implementation.

FIG. 1B is an elevation cross-sectional schematic view of an apparatus for electrorefining a ferrous molten metal in accordance with another implementation.

FIG. 10 is an elevation cross-sectional schematic view of an apparatus for electrorefining a ferrous molten metal in accordance with a further implementation.

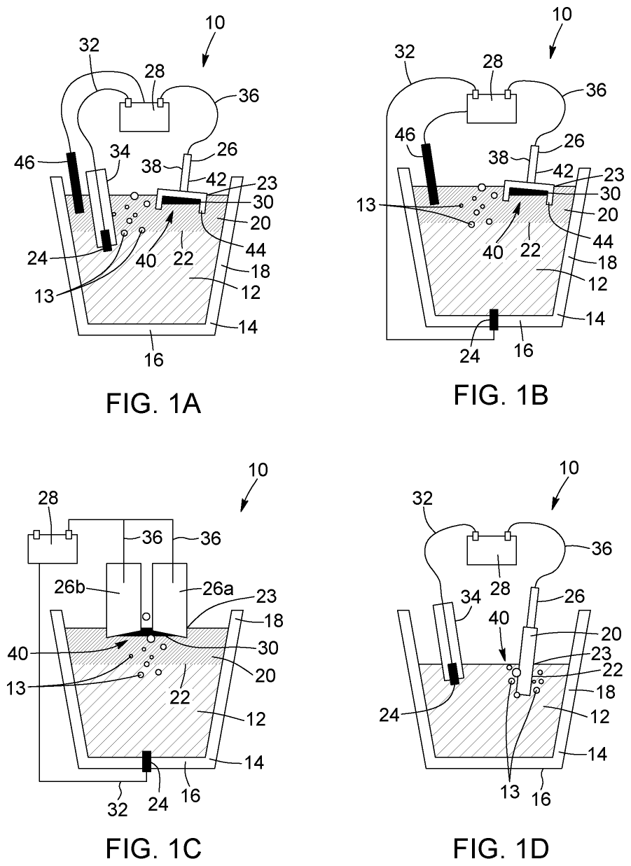

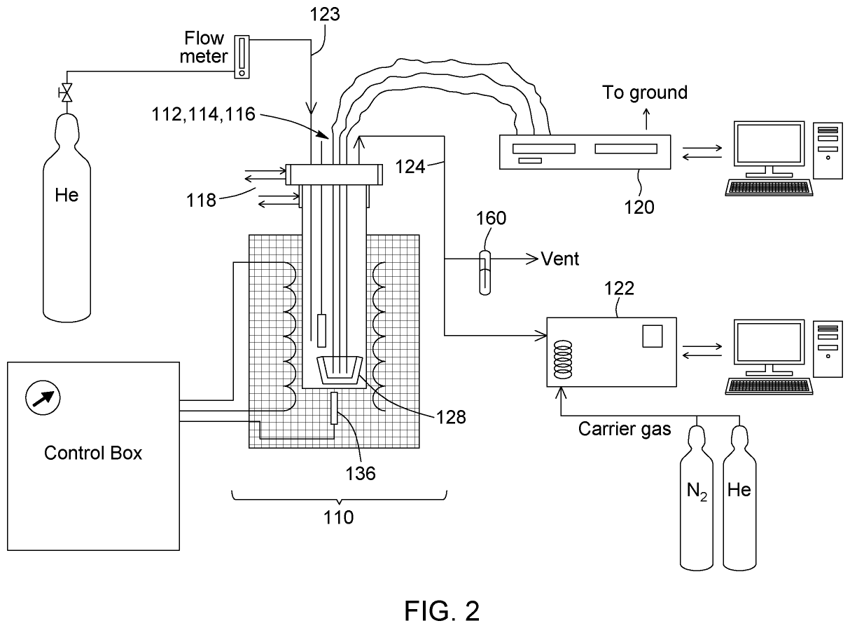

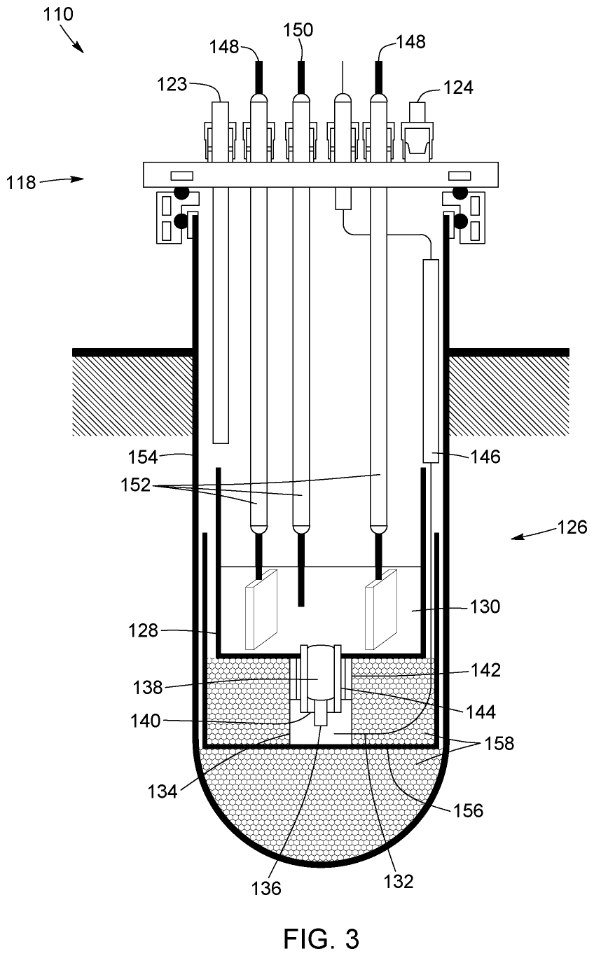

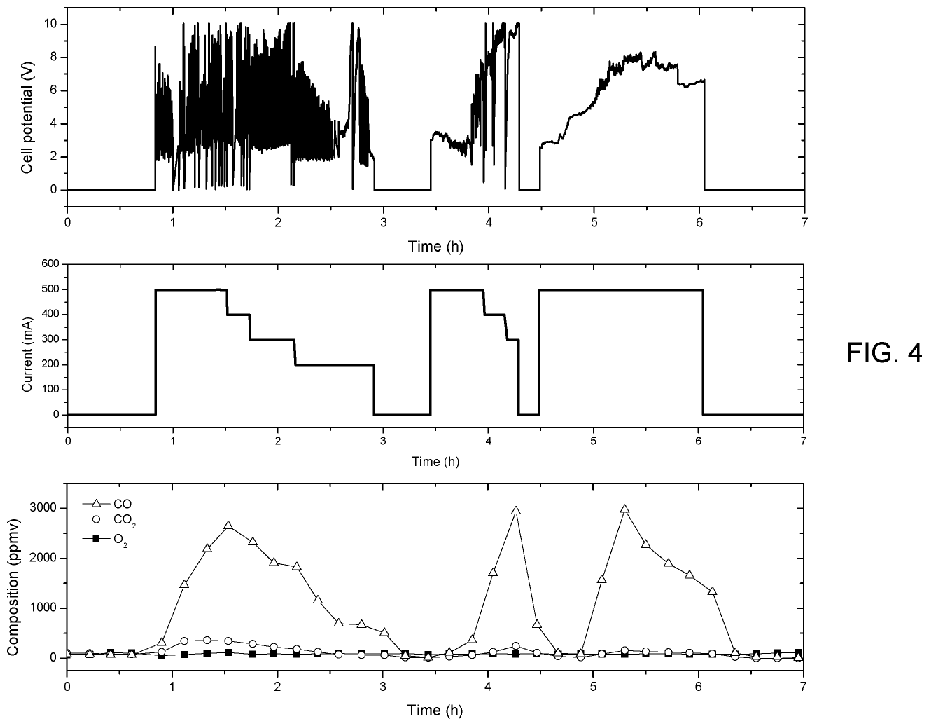

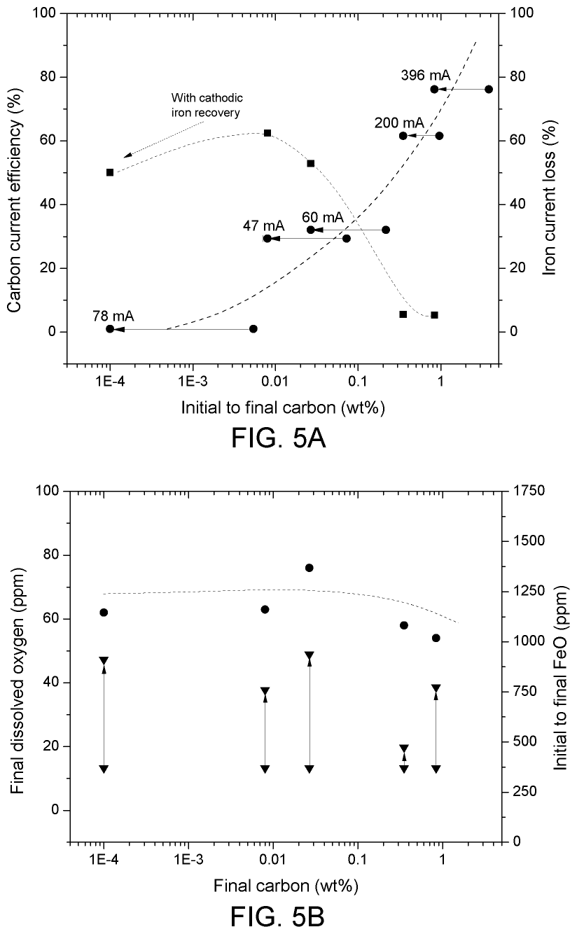

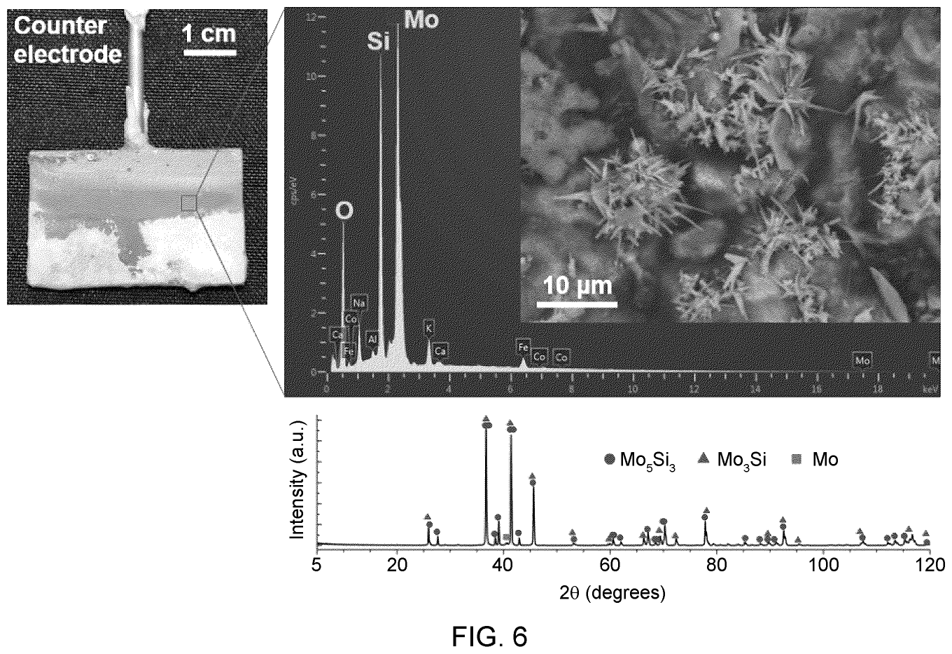

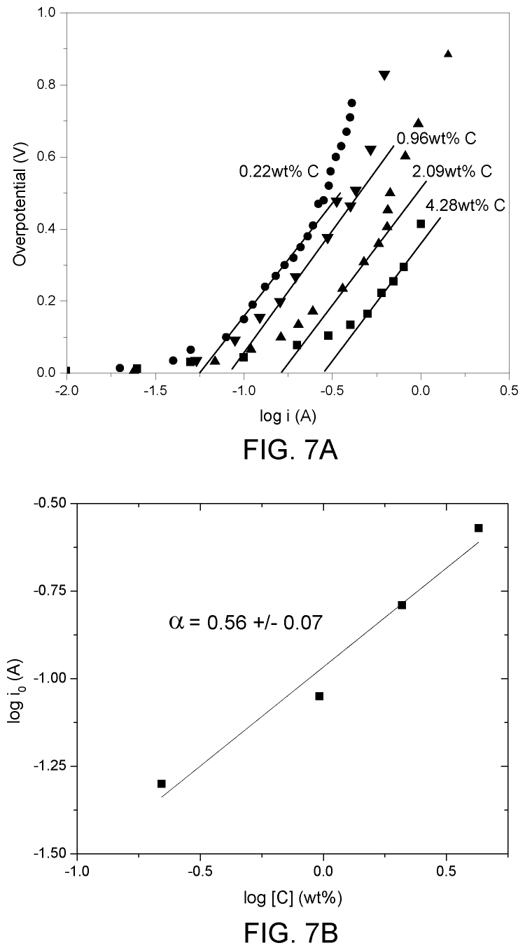

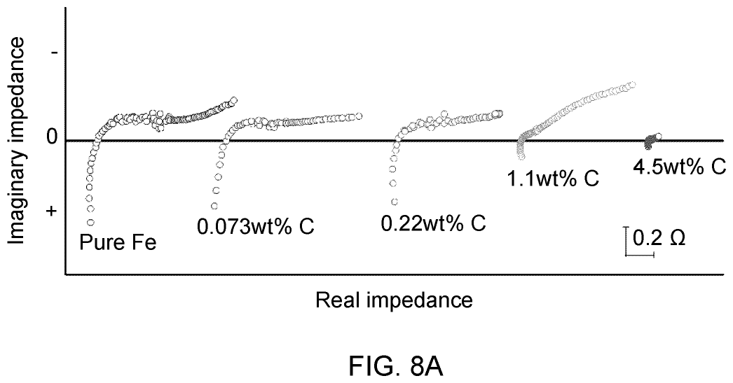

FIG. 1D is an elevation cross-sectional schematic view of an apparatus for electrorefining a ferrous molten metal in accordance with yet another implementation.

FIG. 2 schematically illustrates a furnace assembly that includes an apparatus for electrorefining a ferrous molten metal in accordance with another implementation.

FIG. 3 is an elevation cross-sectional schematic view of a furnace assembly in accordance with a further implementation.

FIG. 4 is a graph showing electrorefining of Fe-3.78 wt % C at 1600° C. under constant current modulation.

FIGS. 5A and 5B are graphs showing carbon current efficiencies for carbon refining and iron lost to the slag, and final dissolved oxygen relative to final carbon contents.

FIG. 6 is a postmortem characterization of the counter electrode by SEM/EDS compositional analyses and XRD, showing the deposition of metallic silicon.

FIGS. 7A and 7B are graphs showing dependence of potential-log current curves and exchange current density on carbon concentration.

FIGS. 8A and 8B are graphs showing the dependence of impedance spectrum at the rest potential on carbon concentration.

FIG. 9 is a graph showing first order kinetic plot determining rate constants.

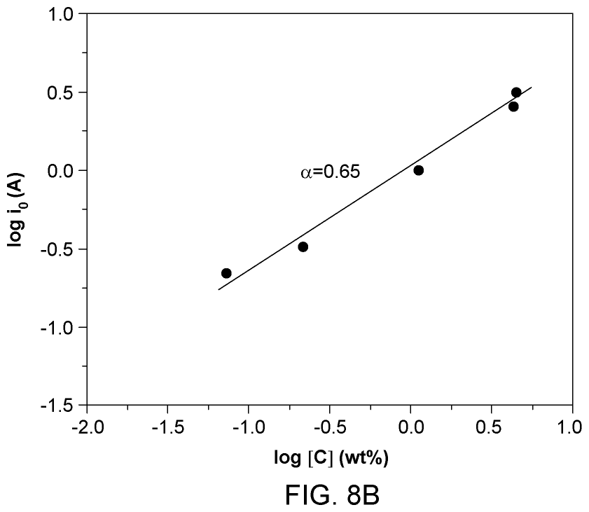

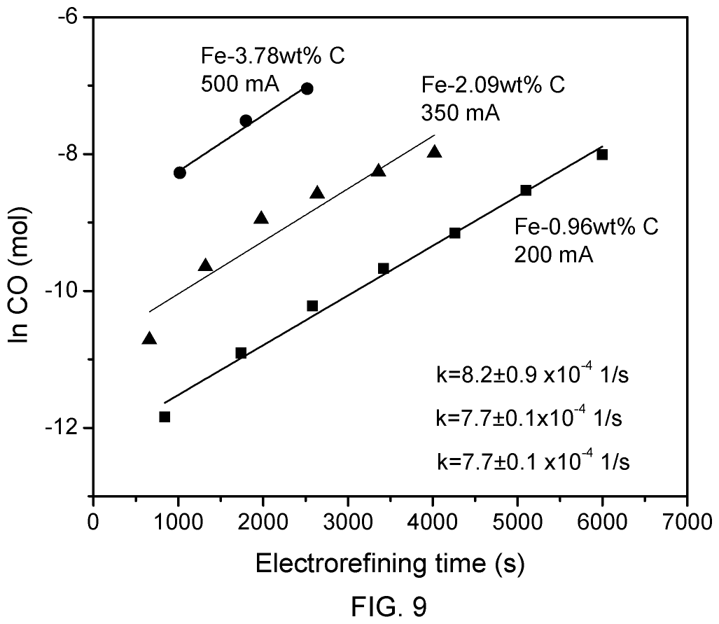

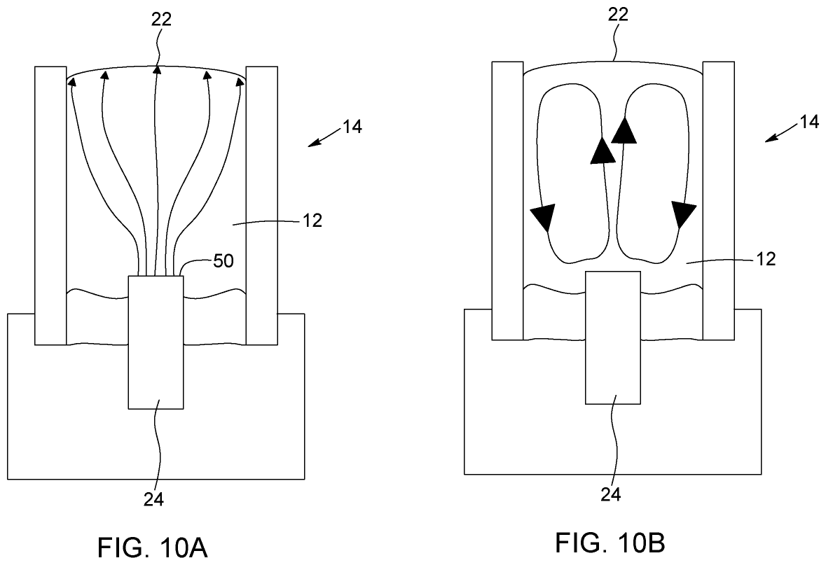

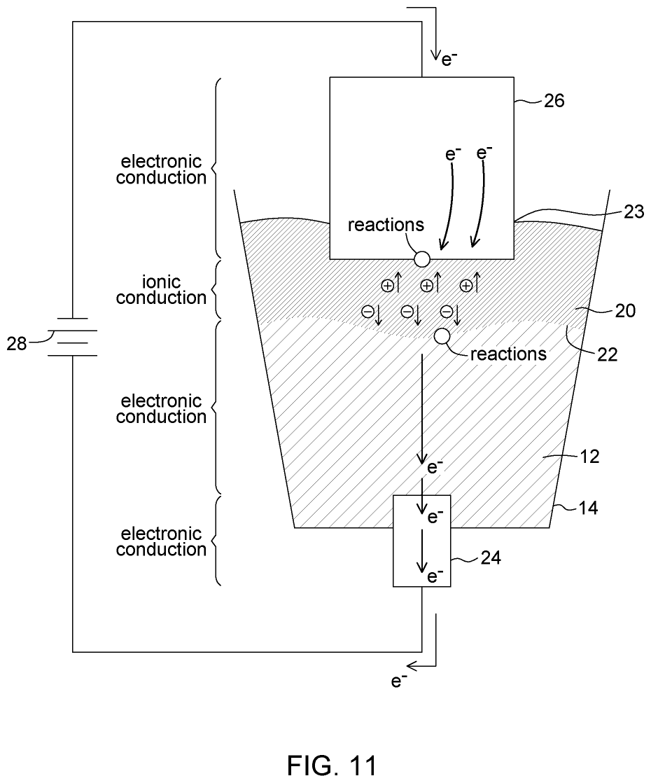

FIGS. 10A and 10B illustrate a configuration of an electrode connection, in accordance with one implementation, that can promote electro-vortex mixing within the ferrous molten metal (12).

FIG. 11 illustrates a method for electrorefining a ferrous molten metal in accordance with one implementation.

### DETAILED DESCRIPTION

Electrorefining cells and methods for electrorefining ferrous molten metals that include iron and impurities are described herein. Indeed, molten ferrous metals, such as molten steels, molten iron-alloys (e.g., molten pig iron or crude iron) and the like, which are in the liquid state, and which include impurities, such as carbon, sulfur, oxygen, phosphorus, copper and the like, can be purified using the electrorefining cells and electrorefining methods described below, so ferrous molten metals which are depleted of the impurities can be obtained. Such purified ferrous metals can be involved in the production of high value metals, such as stainless steels, or ultra-low carbon steels, as the obtained ferrous molten metals which are depleted of the impurities can reach impurities contents below 1 ppm, for example.

In one implementation, the ferrous molten metal to be refined can be contained in a treatment ladle with an ionic molten electrolyte on top of it so as to form a metal-electrolyte interface therebetween. In one scenario, steelmaking slag which is formed on top of the molten steel can act as the molten electrolyte. An electrode connection, made of an electronically conductive material, can be put into contact with the ferrous molten metal for electronic conduction therewith, while a counter electrode, also made of an electronically conductive material, can be put into contact with the molten electrolyte so as to form an electrolyte-counter electrode interface. As the electrode connection can be made of a material which remains in the solid form in the ferrous molten metal and which is substantially inert to the ferrous molten metal, the counter electrode, on its end, can be made of a material which remains in the solid form in the molten electrolyte and which is substantially inert to the molten electrolyte. For example, the electrode connection can be made of an electronically conducting ceramic that includes one or more refractory metal boride(s) for instance.

During electrorefining operations, an electromotive force can be supplied between the electrode connection and the counter electrode so as to induce electrochemical reactions to occur at both the metal-electrolyte interface and the electrolyte-counter electrode interface. The ferrous molten metal which is depleted of the impurities can thus be obtained. Where the ferrous molten metal is a steel or an iron-alloy which has a specific carbon content, decarburization of the steel or iron-alloy can be performed. It is noted that in some implementations, the molten electrolyte or slag can be replaced by a solid electrolyte, as long as interfaces can be formed, between the ferrous molten metal and the electrolyte, as well as between the electrolyte and the counter electrode, as it will be described in more details below.

Therefore, the ferrous molten metal can act as a first electrode, while the counter electrode can act as a second electrode. The electromotive force can be provided therebetween to release the impurities from the ferrous molten metal. Removal of the impurities from the ferrous molten metal can thus be enhanced to reduce the impurities content of the ferrous molten metal, increasing the overall purity of the metal. In some implementations, while the ferrous molten steel can be cleaned of the impurities, one or more valuable reaction by-product(s) can be recovered and collected at the counter electrode, including silicon, metallurgical grade silicon or aluminum. These reaction by-products can be used in the steel plant, for example. The material forming the counter electrode can even form an alloy with the reaction by-product. Additionally, metal values lost to the molten electrolyte or slag can also be recovered electrochemically. The electrorefining processes and cells described below need low energy input, require low capital investment costs, as well as low operating expenditures to produce substantially pure ferrous metals, such as steels, with impurities contents as low as less than 1 ppm, as it will be described in more details below.

Referring now to the drawings and more particularly to FIG. 1A, there is shown a treatment ladle (14) which is shaped, sized and configured so as to contain the ferrous molten metal (12) therein. As discussed above, the ferrous molten metal (12) can include steel or iron-alloy, while the impurities (13) can include carbon, sulfur, oxygen, phosphorus, or any undesirable surface-active chemical element that can reduce the quality or performance of the metal. The ferrous metal (12) thus needs to be liquid during the refining process. For example, if the ferrous metal is steel, it can have a temperature higher than about 1538° C. during the electrorefining operations (i.e., slightly above melting point of steel). The treatment ladle (14) includes a bottom (16) and a peripheral wall (18), which upwardly extends therefrom. A molten electrolyte (20) floats on top of the ferrous molten metal (12) so as to cover, at least in part, the top surface defined by the ferrous molten metal layer. For example, the slag that is formed on top of the ferrous molten metal (12) can act as molten ionic electrolyte (20). As shown, a metal-electrolyte interface (22) can thus be provided between the ferrous molten metal (12) and the molten electrolyte or slag (20). The treatment ladle (14) can be configured to receive more than about 10 tons, more than about 50 tons, more than about 100 tons, or more than about 150 tons of molten metal (12).

In some implementations, the thickness of the ferrous molten metal (12) can be between about 2 cm and about 300 cm, between about 10 cm and about 200 cm, or between about 50 cm and about 150 cm, while the thickness of the molten electrolyte (20) can be between about 2 cm and about 200 cm, between about 5 cm and about 100 cm, or between about 5 cm and about 50 cm. Therefore, the thickness of the molten electrolyte (20) can be between about 1% and about 30%, between about 4% and about 20%, or between about 5% and about 15% the thickness of the ferrous molten metal (12).

Still referring to the implementation of FIG. 1A, there is shown that the electrorefining apparatus or cell (10) can include an electrode connection (24), made of an electronically conductive material, which is put into contact with the ferrous molten metal (12) for electronic conduction therewith, as well as a counter electrode (26), also made of an electronically conductive material, which is put into contact with the molten electrolyte (20) so as to form an electrolyte-counter electrode interface (23). As mentioned above, the electrode connection (24) is made of a material which remains in the solid form when put into contact with the ferrous molten metal (12), while the counter electrode (26) is made of a material which remains in the solid form when put into contact with the molten electrolyte (20). It is further noted that the electrode connection (24) is substantially inert to the ferrous molten metal (12) and that the counter electrode (26) is substantially inert to the molten electrolyte (20). Thus, during the electrorefining operations, none of the electrode connection (24) or the counter electrode (26) is consumed or degraded in the ferrous molten metal (12) and the molten electrolyte (20), respectively. For example, the electrode connection (24) can take the shape of a rod or any other shape, as long as the electrons can be transferred to and from the metal.

The apparatus (10) further includes a power supply (28), in electrical communication with both the electrode connection (24) and the counter electrode (26) for imposing an electromotive force between the electrode connection (24) and the counter electrode (26) so as to induce electrochemical reactions to occur at both the metal-electrolyte interface (22) and the electrolyte-counter electrode interface (23). The impurities (13) can thus be selectively reacted and removed from the ferrous molten metal (12) during the refining operations such that the ferrous molten metal depleted of the impurities (13) can be obtained, after a certain retention time. Indeed, the impurities (13), which have a chemical attraction with the molten electrolyte (20), can flow through the ferrous molten metal (12) towards the metal-electrolyte interface (22), as being attracted by it. The impurities (13) can be released from the liquid ferrous metal as an ionic or neutral compound dissolved in the ionic molten electrolyte (20), or by forming a gaseous phase that naturally issues from the metal-electrolyte interface (22) to reach the molten electrolyte (20). For example, the retention time for performing the refining operations and reducing the impurities content below a specific threshold can be between about 0.1 hour and about 10 hours, between about 0.5 hour and about 5 hours, or between about 0.5 hour and about 2 hours. The retention time can correspond to an amount of time sufficient so that the impurities content of the ferrous molten metal depleted of the impurities is between about 0.01% and about 80%, between about 0.1% and about 50%, or between about 1% and about 10% the impurities content of the ferrous molten metal (12). It is noted that the apparatus or cell (10) can allow the refining operations to be performed under oxidizing atmosphere, under an inert atmosphere, or under a vacuum atmosphere.

As best shown in FIG. 11, as the electrode connection (24) and the ferrous molten metal (12) are both electronic conductors, the electrode connection (24) can supply or accept electrons to or from the ferrous molten metal (12) without hindrance and readily control or measure the electric potential of the ferrous molten metal (12) and metal-electrolyte interface (22). Since the cell (10) includes an ionic electrical conductor (i.e., the molten electrolyte (20)) connected in series with an electronic electrical conductor (i.e., the combination ferrous molten metal (12) and electrode connection (24)), the passage of current or control or measure of potential through the system remains only possible through electrochemical reaction at their interface (i.e., the interface between the ferrous molten metal (12) and the molten electrolyte (20)), which is a means for converting electronic current to ionic current or vice versa. By avoiding use of an electrode connection with ionic conduction, the present implementation involves fewer instances of change between ionic and electronic conduction in the circuit, thereby isolating electrochemical reactions occurring in the cell to those of interest at the metal-electrolyte interface (22) and providing a means for directly controlling or measuring the potential at the metal-electrolyte interface (22).

Optionally, a reaction by-product (30) can also be recovered and collected at the counter electrode (26). The material forming the counter electrode (26) can also form an alloy with the recovered by-product (30). Additionally, metal values lost to the molten electrolyte or slag (20) can also be recovered electrochemically. In one scenario, such recovery can be performed for the ferrous molten metal that has been oxidized inadvertently during the electrorefining operations. In another scenario, the recovery can be performed for the ferrous molten metal that has been dispersed as droplets or as an emulsion through the molten electrolyte (20) during the electrorefining operations. High purity metals such as steels can thus be obtained in a single reactor or in a continuous process.

In some implementations, the impurities content of the ferrous molten metal (12), prior to the electrorefining operations, can be between about 0.01% and about 10%, between about 0.05% and about 5%, or between about 0.1% and about 1%. In other implementations, the impurities content of the ferrous molten metal (12), prior to the electrorefining operations, can be between about 40 ppmw and about 100 ppmw, between about 50 ppmw and about 90 ppmw, or between about 60 ppmw and about 80 ppmw. On the other hand, the impurities content of the ferrous molten metal depleted of the impurities (13) obtained, after the refining operations, can be below about 100 ppmw, below about 75 ppmw, below about 50 ppmw, below about 10 ppmw, or below a threshold so as to be suitable for the production of stainless steels or ultra-low carbon steels, for example.

### Electrode Connection

In one implementation, the electrode connection (24) can be made of a material which has a melting temperature which can be higher than the melting temperature of the ferrous molten metal (12). For example, the melting temperature of the connection material can be higher than about 1600° C., higher than about 1700° C., or higher than about 1800° C.

In one scenario, the material forming the electrode connection (24) can be an electronically conducting ceramic. For example, the material forming the electrode connection (24) can include one or more refractory metal boride(s), such as, zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof. Other refractory metal borides can be used. In one scenario, the material can include between about 40% v/v and about 100% v/v, between about 50% v/v and about 95% v/v, or between about 60% v/v and about 90% v/v of a specific refractory metal boride, or of a mixture of different refractory metal borides. Indeed, the material forming the electrode connection (24) does not necessarily need to be a monolithic material, but can be a composite which contains a portion of the refractory metal boride(s). Thus, in one scenario, the connection material can be solid at steelmaking temperatures (e.g., up to about 1900° C.), inert to molten steel, and a highly thermal and electronically conducting ceramic material.

Still referring to the implementation of FIG. 1A, the apparatus (10) further includes an electrode connection wire (32) which electrically connects the electrode connection (24) to the power supply (28). As shown, the apparatus (10) can further include a protective sheath (34) for receiving the electrode connection (24) and the electrode connection wire (32) therein, at least in part, for protection against the ferrous molten metal (12) (e.g., an insulating sheath for receiving the electrode connection wire (32) therein, at least in part). The electrode connection (24) can be submerged or dipped into treatment ladle (14) or bath from above for electronic conduction with the ferrous molten metal (12). Thus, the electrode connection (24) forms the electronic conduction to the ferrous molten metal (12), which allows current or potential to be modulated at the metal-electrolyte interface (22) (e.g., the steel-slag interface). For example, the surface area of the electrode connection (24) can be between about 0.1% and about 95%, between about 0.5% and about 85%, or between about 1% and about 70% the surface area of the metal-electrolyte interface (22).

### Counter Electrode

In one implementation, and as mentioned above, the counter electrode (26) can be made of a material which can remain in the solid form when put into contact with the molten electrolyte (20). For example, that electrode material can have a melting temperature higher than about 1600° C., higher than about 1700° C., or higher than about 1800° C. The material is electronically conducting and can be resistant to oxidative atmospheres. While being substantially inert to the molten electrolyte (20), as mentioned above, the material forming the counter electrode (26) can also be inert to the reaction by-product (30). In some scenarios, the counter electrode (26) can include, without limitation, molybdenum (Mo), graphite (C), carbon (C), tantalum (Ta), niobium (Nb), chromium (Cr), platinum group metals, and the like. In other scenarios, the material can include one or more refractory metal boride(s), such as, zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof. Other refractory metal borides can be used. For example, the counter electrode (26) can include between about 40% v/v and about 100% v/v, between about 50% v/v and about 95% v/v, or between about 60% v/v and about 90% v/v of one or more of these materials. In other words, the counter electrode (26) can be solid at steelmaking temperatures, can be inert to the molten electrolyte (20), and can have a high electronic conductivity.

Still referring to the implementation of FIG. 1A, the apparatus (10) further includes a counter electrode wire (36) which electrically connects the counter electrode (26) to the power supply (28). The apparatus (10) can also include a protective sheath (38) for receiving the counter electrode (26) and the counter electrode wire (36) therein, at least in part, for protection against the molten electrolyte (20). In one scenario, the protective sheath (38) can be made of a ceramic, of a material comprising graphite or of any other material that can be suitable to protect the counter electrode (26) from the molten electrolyte (20). As shown, the counter electrode (26) can be submerged or dipped, at least in part, from above, into the molten electrolyte (20) so as to form the interface (23). The counter electrode (26) can be positioned within the molten electrolyte (20), substantially opposite to the metal-electrolyte interface (22), and can be configured so as to collect the reaction by-product (30). In one scenario, the counter electrode (26) can include a by-product collection area (40), which can face the metal-electrolyte interface (22) once the counter electrode (26) is submerged into the molten electrolyte (20), for example, to collect the reaction by-product (30) produced during the electrorefining operations. As shown, the counter electrode (26) can include an upper section (42) and a lower section (44) extending from the upper section (42). A cavity can be formed within the lower section (44) to act as the by-product collection area (40). The counter electrode (26) can take any shape, size or configuration, so that liquid metal or alloy by-products can easily be collected during the electrorefining operations. In one implementation, the surface area of the counter electrode (26), and more particularly, the surface area defined by the by-product collection area (40) can be between about 10% and about 200%, between about 20% and about 100%, or between about 30% and about 80% the surface area of the metal-electrolyte interface (22). Thus, the counter electrode (26) is put into contact with the molten electrolyte (20) and can provide a site for counter electrode reactions to occur. For example, the counter electrode (26) can have a surface area that is sufficient so that the electrode reactions occurring at the counter electrode (26) do not require significant reaction overvoltage. As mentioned above, the counter electrode (26) can be positioned at a distance from the metal-electrolyte interface (22). For example, the distance between the counter electrode (26) and the metal-electrolyte interface (22) can be between about 1 cm and about 50 cm, between about 2 cm and about 20 cm, or between about 2 cm and about 10 cm. A sufficient distance can be provided between the ferrous molten metal (12) and the counter electrode (26). While the counter electrode (26) is illustrated as being positioned opposite to the metal-electrolyte interface (22) in the implementation of FIG. 1A, it is noted that the counter electrode (26) can be located elsewhere in the molten electrolyte (20).

Now referring more particularly to the implementations of FIGS. 1B and 10, it is noted that, instead of being submerged or dipped into the ferrous molten metal (12) from above, the electrode connection (24) can extend from the bottom (16) of the treatment ladle (14), as shown in FIGS. 1B and 10, or alternatively, from the peripheral wall (18) of the treatment ladle (14) (not shown). In other words, the electrode connection (24) can take any shape, size or configuration or extend from any other metal making equipment adjacent to the treatment ladle (14), as long as at least a portion of the electrode connection (24) can be put into contact with the ferrous molten metal (12) for electronic conduction therewith, so the metal can act as the first or working electrode. Indeed, the electrode connection (24) only serves to transport electrons to and from the ferrous molten metal (12) and therefore, the electrode connection (24) can be connected to another material which can be, for example, a less exotic, less expensive, more conventional electronic conductor (e.g., metals, alloys, graphite, etc.). Moreover, in one scenario, the electrode connection (24) can be positioned substantially adjacent to the metal-electrolyte interface (22), as shown in the implementations of FIGS. 1A and 1D, or can be positioned substantially opposite to the metal-electrolyte interface (22), as shown in the implementations of FIGS. 1B and 10.

Similarly, instead of being submerged or dipped into the molten electrolyte (20), it is noted that the counter electrode (26) can extend from the peripheral wall (18) of the treatment ladle (14) (not shown) or other metal making equipment adjacent to the treatment ladle (14), as long as the counter electrode (26) can contact, at least in part, the molten electrolyte (20).

The electrode connection (24) and the counter electrode (26) can take any shape, size or configuration, as long as they are made of an electronically conductive material, and that they can interface with the ferrous molten metal (12) and the molten electrolyte (20), respectively, so electrochemical reactions can occur at both the interface (22) and (23), allowing conversion of electronic current to ionic current, or vice versa. For example, the electrode connection (24) can take the shape of a rod, as shown in the implementations of FIGS. 1A to 1D, but other configuration will provide the electronic conduction.

It is further noted that the apparatus (10) can include more than one electrode connections to be put into contact with the ferrous molten metal (12) for electronic conduction therewith, and/or more than one counter electrode (26) to be put into contact with the molten electrolyte (20) for forming multiple interfaces (23), as shown in the implementation of FIG. 10 (e.g., counter electrodes 26a, 26b). Additionally, as shown in the implementation of FIG. 10, lower sections of the counter electrodes 26a, 26b can define angled surfaces of opposite slopes, to enhance recovery and collection of the reaction by-product (30) at the counter electrodes (26a, 26b) during the electrorefining operations. A by-product collection area (40) is indeed formed about the angled surfaces.

### Molten Electrolyte

As mentioned above, the impurities (13) and the molten electrolyte (20) can have a chemical affinity, so that the impurities (13) can cross the metal-electrolyte interface (22) during the electrorefining operations. The molten electrolyte (20) can also have a chemical affinity with the reaction by-product (30). In one scenario, the molten electrolyte (20) can be in the liquid state during the refining operations and can have a melting temperature higher than about 1300° C., higher than about 1400° C., or higher than about 1500° C. It can be advantageous to have a molten electrolyte (20) that has a melting temperature that is lower than the melting temperature of the ferrous metal, as the molten electrolyte (20) can remain more fluid at the refining temperature. As shown in the implementation of FIG. 1A, the molten electrolyte (20) can float on top of the ferrous molten metal (12). Therefore, it is noted that the molten electrolyte (20) can have a density which is lower than the density of the ferrous molten metal (12). The density of the molten electrolyte (20) can further be higher than the density of the reaction by-product (30). For example, the molten electrolyte (20) can have a density of between about 2 g/cm³ and about 7 g/cm³, of between about 2.2 g/cm³ and about 6 g/cm³, or of between about 2.5 g/cm³ and about 5.5 g/cm³, can have a viscosity of between about 0.1 poise and about 5 poise, between about 0.5 poise and about 4 poise, or between about 1 poise and about 3 poise, and can have a vapour pressure below about 0.01 atm, below about 0.001 atm, or below 0.0001 atm. In other words, the electrolyte (20) can be in the liquid form at steelmaking temperatures, and can have a low viscosity as well as a low vapour pressure.

In one implementation, the molten electrolyte (20) can be an ionic conductor and can include one or more oxide(s), sulfide(s), chloride(s), fluoride(s), and the like. In one scenario, oxides such as calcium oxide (CaO), aluminium oxide (Al₂O₃), silicon dioxide (SiO₂), magnesium oxide (MgO), taken alone or in combination, can form the molten electrolyte (20). For example, a mixture of 100% oxides (e.g., CaO, Al₂O₃, SiO₂, and MgO) can float on top of the ferrous molten metal (12), of the mixture can include other oxides not listed or other components that have a desirable influence on the electrolyte performance (e.g., sulfides, chlorides, fluorides, etc.). This ionic conductor remains in intimate contact with both the ferrous molten metal (12) and the counter electrode (26). The molten electrolyte (20) can be compositionally designed such that it has a desired chemical affinity with the impurities (13) that need to be released from the ferrous molten metal (12) during the electrorefining operations. For example, the slag (20) can include oxide (CaO), aluminium oxide (Al₂O₃), silicon dioxide (SiO₂), and magnesium oxide (MgO), and more particularly, can include between about 10% and about 60% of CaO, between about 1% and about 60% of Al₂O₃, between about 1% and about 20% of SiO₂, and between about 1% and about 30% of MgO. The slag (20) can also include iron oxides (FeO, Fe₂O₃, Fe₃O₄), and more particularly, between about 1% and about 20% of iron oxides.

As shown in the implementation of FIG. 1A and as mentioned above, the ferrous molten metal (12) to be refined can be contained in the treatment ladle (14). Instead of having a molten electrolyte or slag that floats on top of the ferrous molten metal (12), as shown in the implementations of FIGS. 1A to 10, the electrolyte (20) can alternatively be in the solid form and be put into contact with the ferrous molten metal (12) so as to form the metal-electrolyte interface (22), as shown in the implementation of FIG. 1D. The metal-electrolyte interface (22) is thus formed between a liquid metal and a solid electrolyte (20), instead of between a liquid metal and a liquid electrolyte. Similarly, the electrode connection (24) is put into contact with the ferrous molten metal (12) for electronic conduction therewith, while the counter electrode (26) is put into contact with the solid electrolyte (20) so as to form the electrolyte-counter electrode interface (23). Therefore, during the electrorefining operations, the electromotive force is supplied via the power source (28) between the electrode connection (24) and the counter electrode (26) so as to induce the electrochemical reactions to occur at both the metal-electrolyte interface (22) and the electrolyte-counter electrode (23). The ferrous molten metal which is depleted of the impurities (13) is thus produced. Indeed, referring back to FIG. 11, as the electrode connection (24) and the ferrous molten metal (12) are both electronic conductors, the electrode connection (24) can supply or accept electrons to or from the ferrous molten metal (12) without hindrance and readily control or measure the electric potential of the ferrous molten metal (12) and metal-electrolyte interface (22). Since the cell (10) includes an ionic electrical conductor (i.e., the solid electrolyte (20)) connected in series with an electronic electrical conductor (i.e., the combination ferrous molten metal (12) and electrode connection (24)), the passage of current or control or measure of potential through the system remains only possible through electrochemical reaction at their interface (i.e., the interface between the ferrous molten metal (12) and the solid electrolyte (20)), which is a means for converting electronic current to ionic current or vice versa. It is noted that the solid electrolyte (20) can be configured to be displaceable relative to the ferrous molten metal (12), allowing the interface (23) to be displaced in the slag for example. Displacing the solid electrolyte (20) in the ferrous molten metal (12) during the electrorefining operations can enhance the collection of the impurities (13) as it can be easier to pick up them in the steel bath.

Still referring to the implementation of FIG. 1D, in the case where the electrolyte is a solid electrolyte (20), the impurity (13) can be evolved as a gas (e.g., carbon) or can be collected inside the solid electrolyte (20) at a first electrolyte side, for example, the one near the metal-electrolyte interface (22). On the other hand, the reaction by-product (30) can be collected at an opposite second electrolyte side of the solid electrolyte (20), for example, the one in contact with the counter electrode (26). While the implementation of FIG. 1D can be less practical for recovering the reaction by-product (30), it can be advantageous as the solid electrolyte (20) can be displaced within the ferrous molten metal (12), as mentioned above. The implementation of FIG. 1D can also be of interest, because impurities (13) that dissolve in the solid electrolyte (20) can be collected, so afterwards, the solid electrolyte (20) can be disposed of, and alternatively, replaced so as to restore its affinity for the impurity or impurities (13) that are of interest.

### Power Supply

It is noted that the power supply (28) can be configured to provide a current and/or potential to be modulated at the metal-electrolyte interface (22). Indeed, in one scenario, the power supply (28) can be configured to modulate potential, which can be direct potential, alternating potential or a combination thereof. However, in another scenario, the power supply (28) can be configured to modulate current, which can be direct current, alternating current or a combination thereof. For example, the potential can be between about 0.01 V and about 30 V, between about 0.1 V and about 10 V, or between about 0.5 V and about 5 V, while the current can be between about 1 mA/cm² and about 5000 mA/cm², between about 10 mA/cm² and about 1000 mA/cm², or between about 50 mA/cm² and about 500 mA/cm². The power supply (28) can thus induce the desired electrochemical reactions to occur at the metal-electrolyte interface (22) and at the counter electrode (26) (i.e., at the electrolyte-counter electrode interface (23)). Thus, the electromotive force can be modulated via direct current or potential, alternating current or potential, or repeating wave forms or pulses (e.g., triangular, square, etc.). Fast galvanic pulses or fast galvanic pulses separated by fast pulses of the opposite polarity, and smaller in magnitude, can also be used. The electromotive force can be optimized with respect to, for example, the composition of the ferrous molten metal (12), the stage of the electrorefining operations, the temperature of the ferrous molten metal (12), etc. Such optimization can be possible as the quantitative thermodynamic and kinetic data have been measured for different contents of impurities, different impurities and different temperatures of the liquid metal, as it will be described in more details below.

### Auxiliary Electrode

In one implementation, and as best shown in FIGS. 1A and 1B, the apparatus (10) can optionally include an auxiliary electrode (46), which can be put into contact with the molten electrolyte (20), so as to electrochemically measure the impurities content of the ferrous molten metal (12). The auxiliary electrode (46) can act as a reference electrode with a determined thermodynamic electrode potential. As shown, the auxiliary electrode (46) can be submerged or dipped, at least in part, from above, into the treatment ladle (14), for interfacing with the molten electrolyte (20). However, it is noted that the auxiliary electrode (46) can extend from the peripheral wall (18) of the treatment ladle (14), as long as it can be put into contact with the molten electrolyte (20). In one scenario, the auxiliary electrode (46) can be made of a material which is substantially inert to the molten electrolyte (20), and electronically conducting. For example, such material can include molybdenum (Mo). Incorporating an auxiliary electrode (46) which acts as a reference electrode in contact with the molten electrolyte (20) can help distinguishing the potential of the ferrous molten metal (12) and the counter electrode (26) from that of the total cell potential. The auxiliary electrode (46) can thus be used to monitor sensitive electrochemical signals of the ferrous molten metal (12) and/or the electrolyte (20) during the electrorefining operations. The electrochemical signals can be determined, for example, by potential, polarization characteristics, impedance spectroscopy, etc. The electromotive force can thus be adjusted, in real time for example, relative to the electrochemical signals that are monitored. In some scenarios, the electromotive force can be adjusted relative to the impurities content of the ferrous molten metal (12), the reaction by-product content of the molten electrolyte (20), the composition of the ferrous molten metal (12), the composition of the impurities (13), the stage of the electrorefining operations, the temperature of the ferrous molten metal (12), etc. It is noted that apparatus (10) can include more than one auxiliary electrode (46) to be put into contact with the molten electrolyte (20).

In some implementations, and as shown in FIGS. 10A and 10B, the electrode connection (24) can be shaped, sized and configured so as to promote electro-vortex mixing within the treatment ladle (14), and more particularly, to promote electro-mixing of the ferrous molten metal (12). Accordingly, the surface area of the electrode connection (24), or diameter of the rod for example, or the interface electrode connection-metal (50), can be less than the surface area of the metal-electrolyte interface (22), or diameter of the treatment ladle (14) for example, or metal-electrolyte interface (22). In one scenario, the surface area of the electrode connection (24) can be between about 0.1% and about 95%, between about 0.5% and about 85%, or between about 1% and about 70% the surface area of the metal-electrolyte interface (22).

In one scenario, the electrorefining processes for electrorefining impurities from molten steels or iron-alloys are provided to perform the refining by imposing an electromotive force between a liquid steel or iron-alloy and the slag formed on top of it, while existing technologies seek to manipulate partial pressure, slag chemistry, or steel chemistry to achieve such refining operations. Electrochemical decarburization of molten steel or molten iron-alloy can thus be performed over the entire carbon composition range from the eutectic composition (4.3 wt % carbon in iron) to a composition of about 50 ppmw of carbon in steel. Refining of iron-carbon alloys from high carbon (4.3 wt %) to ultra-low levels (<1 ppmw) can indeed be performed. Molten electrorefining can thus be used to produce stainless steels or ultra-low carbon steels containing less than about 1 ppmw of carbon, with high efficiency, low energy requirements, and no chemical reagents. Recovery of valuable silicon metal or ferrosilicon alloy as a reaction by-product can also be performed, and these recovered by-products can be of many uses in steelmaking. These processes can be operated with good coulombic efficiency and low energy consumption. For example, energy consumed during the electrorefining operations can be between about 1 kWh/kg and about 50 kWh/kg of impurities, between about 5 kWh/kg 40 kWh/kg of impurities, or between about 10 kWh/kg and about 20 kWh/kg of impurities or carbon. Alternatively, the energy consumed during the electrorefining operations can be between about 1 kWh/t and about 2000 kWh/t of ferrous molten metal, between about 100 kWh/t and about 1500 kWh/t of ferrous molten metal, or between about 500 kWh/t and about 1000 kWh/t of ferrous molten metal or molten steel. Metal values lost to the slag can also be recovered electrochemically. The processes described can be used to produce high purity steels in a single reactor and perhaps in a continuous process. The present electrorefining cell or apparatus can also be integrated with existing furnaces, such as RH degassing, vacuum chambers, bottom stirring ladles, etc.

The methods and apparatuses described above have several notable advantages over existing technologies. The electrorefining cells and methods described above can benefit from:

Simple design and operation. The present electrorefining cells need only two electrodes and a suitable electrolyte, namely, the ferrous molten metal, the counter electrode and the molten or solid electrolyte. In operation, only a modulation of current or potential is necessary to perform refining. No chemical precursors, reagents, or deoxidizers (e.g., O₂, Ar, Ca, CaC₂, FeSi, Al, etc.), no vacuum chambers, and no inert atmospheres are necessary. However, such tactics can be used in conjunction with the electrorefining cell. The electrorefining cells described can serve as a stand-alone process and equipment. Alternatively, the electrorefining cells described can be easily adapted to existing equipment and processes to enhance refining beyond actual limits. The simple design and operation of the present electrorefining cells can allow easy adaptation to continuous processing, which improves productivity.

Improved productivity. The electrorefining cells can allow easy adaptation to a continuous process. For example, steelmaking in a continuous manner can afford improved productivity and less material degradation caused by thermal cycling. The present electrorefining cells are flexible and can be quickly adaptable to different scales of production.

Low energy input. The present electrorefining cells allow refining to be performed with the minimum amount of energy supplied by electricity (e.g., operating without an arc means lower power is necessary, liquid slag has high conductivity, etc.). The amount of energy supplied can easily be monitored, controlled, and adjusted through modulation of current or potential. For example, the present methods are capable of decarburizing steel with energy input of between about 10 and 20 kWh/kg of carbon or between about 1 and 1000 kWh/t of steel.

By-production of valuable metals and alloys. While the present cells can achieve selective refining of molten metal such as molten steel at one electrode, the counter electrode can be used to produce and collect a valuable metal or alloy by-product. In one scenario, the counter electrode can constitute the cathode and silicon or ferrosilicon can be produced, naturally separating and coalescing atop the slag owing to its lower density. Such a material can be of common use and need in most plants, such as steelmaking plants. The surface of the liquid metal produced at the cathode can further act as a counter electrode itself, thereby reducing nucleation overpotential,

Recovery of metal values from slag. The present electrorefining cells can allow recovery of metals inadvertently oxidized during refining (e.g., FeO or SiO₂) and those dispersed as droplets within a slag or emulsion. Placing the molten metal or steel as the cathode can allow oxidized species (e.g., FeO and SiO₂) to be reduced and reverted back to the metal phase. As well, imposing an electric field can induce motion of dispersed metal droplets back to the bulk steel by the differential surface tension. In another manner, the surface tension can be controlled by electric potential such to control the tendency for emulsification as desired.

Treatment and production of ultra high purity steel. The present electrorefining cells can achieve electronic connection to molten metal or steel via an inert electrode connection, such as an electronically conducting ceramic (e.g., made of a ZrB₂ or other refractory metal boride(s)). This can allow highly pure metal or steel of high value to be produced, treated, and refined without contamination usually observed through conventional electrodes (e.g., graphite, high melting refractory metals, platinum group metals, etc.). Moreover, the lower need for deoxidizers can mean a lower tendency for formation of oxide inclusions, thereby improving end product quality.

Low or no refractory corrosion. The present cells allow oxidative refining to be conducted with a largely FeO barren slag. The absence of the highly corrosive FeO in the slag, leads to less or no corrosion, wear, and chemical attack of refractory linings. If the process is operated in a continuous manner, degradation of refractories via thermal cycling can also be reduced.

Refining in the presence of slag. The present electrorefining cells can allow to perform, for example, decarburization, with the presence of slag atop the molten metal. Slag has several well-known advantages including: no vaporization loss of metal, less metal dust formation, less heat loss (better heat utilization/thermal efficiency), no pickup of atmospheric contamination (e.g., N, H, etc.).

Easy process control. The present electrorefining cells can allow for easier process control as the electrochemical signals can provide an easy avenue for sensing and monitoring the progress of the refining process. For example, amount of carbon in a molten steel can affect the charge transfer resistance in a predictable manner. In some arrangements, the use of an auxiliary reference electrode can be desirable. It can allow for good end carbon control which improves productivity and efficiency of steelmaking. Good control of the end carbon level can also reduce overall oxidation and can reduce the need for deoxidizers.

Little or no electrode consumption. The present cells utilize inert electronically conducting materials to connect to the molten metal or steel. For example, as this material is inert to molten steel, little or no electrode consumption is observed unlike conventional materials (e.g., graphite, molybdenum). Likewise, in the implementation where the counter electrode is constituted as the cathode, virtually no wear occurs as this electrode is inert. Moreover, current industry electrodes are water-cooled. The electrode connection does not need to be water-cooled, thanks to the high melting point and good thermal conductivity of the electronically conducting materials or ceramics (e.g., refractory metal boride(s)).

Therefore, the apparatuses and methods described herein can require lower capital investment costs, as well as lower operating expenditures, and can provide improved yields compared to conventional steelmaking technologies. The production of high value steels, such as stainless steels and ultra-low carbon steels, which require low levels of carbon, can thus be performed. The required purity can be achieved at lower cost and under a retention time similar to the one needed in conventional processes (e.g., argon oxygen decarburization, vacuum oxygen decarburization, etc.).

### EXPERIMENTS & RESULTS

### 1. Experimental

### 1.1 Experimental Design and Instrumentation

Electrorefining experiments were conducted in a resistance heated (MoSi₂) vertical tube furnace (110) (HTRV 18/100/500, Carbolite Gero) with a 50 cm heated length. A closed one end working tube 4″ OD×3.625″ ID (99.8% alumina, McDanel) was used with an atmosphere of flowing high-purity helium gas (15 L/h, 99.999% pure, Linde). Electrode leads (112, 114, 116) for the working, reference, and counter electrodes exited the furnace through a gas-tight water-cooled flange (118) and connected to a potentio/galvanostat (120) (VersaSTAT 3, Princeton Applied Research). A gas chromatograph (122) (ARNL5424 modified Model 4020, Perkin Elmer) connected directly online to the gas outlet (124) of the furnace (110) was used to measure the composition of the gas exiting the furnace. The experimental setup is shown schematically in FIG. 2.

### 1.2 Cell Design and Furnace Assembly

A schematic depicting the electrochemical cell (126) and furnace assembly (110) is shown in FIG. 3. The electrochemical cell (126) includes a 500 mL primary crucible (128) of 76 mm OD×148 mm H (99.8% alumina, McDanel) used to contain the molten oxide electrolyte (130). A working electrode tube (132) of 17.5 mm OD×11.1 mm ID×20-25 mm L (99.8% alumina, Ceramic Solutions) was set into the bottom of the primary crucible (128) and formed the working electrode area. The working electrode tube (132) extended 4-5 mm into a molybdenum block (134) of 25 mm×25 mm×20 mm (99.97% pure, PlanSee) that formed the working electrode lead.

A zirconium boride (ZrB₂) rod (136) of 5 mm D×10-15 mm H, which is inert to molten iron and steel (138), formed the electronic connection between the steel melt (138) and molybdenum block (134). Zirconium boride was sintered in-house from commercially available powder (99.5% pure, −325 mesh, TYR Tech Material Ltd.). Compacts of 1⅛″ diameter were uniaxially pressed and sintered at 1600° C. for 6 h under flowing helium. Sintered compacts were then sectioned into rods by electric discharge machining. To seal surface porosity, ZrB₂ rods (136) (50% dense) were impregnated with a mixture of alumina cement and water under vacuum.

High-temperature alumina cement (140) (Resbond 989, Contronics Corp.) was used to fill the space between the zirconium boride rod (136) and working electrode tube (132). A support tube (142) of 25.4 mm OD×19.05 mm ID (99.8% alumina, Ceramic Solutions) was placed circumferential to the working electrode tube (144) and bore the weight of the primary crucible (128) and its contents. Three working electrode lead wires of 1 mm D (99.97% pure Mo, PlanSee) were connected to the molybdenum block (134) and ran outside the furnace 110 inside a protective alumina shroud (146).

Two counter electrodes (148) and one reference electrode (150) were utilized in the cell (126). The counter electrodes (148) were fabricated from molybdenum rods of 3 mm D×1000 mm L (99.97% pure, PlanSee) press fit into molybdenum plates of 25 mm×40 mm×4 mm (99.97% pure, PlanSee). The reference electrode (150) was a molybdenum rod of 3 mm D×1000 mm L (99.97% pure, PlanSee). The counter electrodes (148) and reference electrode (150) were protected by alumina sheathing (152) of 6.35 mm OD×4.75 mm ID×914 mm L (99.8% pure, McDanel). In some experiments, two reference electrodes (150) were used (1 mm D wire, PlanSee) through a 6.35 mm OD×1.57 mm ID×1000 mm L double bore alumina tube (154) (99.8%, McDanel). All electrode leads (112, 114, 116) exited the furnace (110) through the cooling flange (118) in gastight Swagelok Ultra-Torr vacuum fittings.

The entire electrochemical cell (126) was placed in a 750 mL containment crucible (156) of 84 mm OD×160 mm H (99.8% alumina, McDanel). The space between the primary and containment crucibles (128, 156) was filled with alumina bubbles (158) (Duralum AB, 99.2% pure, 10/20 grit, Washington Mills) to prevent the cell assembly (126) from shifting. Alumina bubbles (158) were also used to form a bed inside the closed one end furnace tube upon which the containment crucible (156) rested.

### 1.3 Experimental Procedure and Materials

Electrolytes (130) were prepared from CaO (99.5% pure, −325 mesh, Materion), Al₂O₃ (99.9% pure, 20-50 μm, Alfa Aesar), SiO₂ (99.5% pure, <10 μm, Alfa Aesar), and MgO (99.5% pure, −325 mesh, Materion) powders. In all cases, electrolyte composition was fixed at 25 CaO-55 Al₂O₃-11 SiO₂-9 MgO (wt %). Immediately prior to all experiments metal oxide powders were fired in a chamber furnace at 1000° C. for 4 hours in air to decompose any carbonates, hydroxides, and remove any adsorbed gases. Alumina crucibles containing the metal oxide powders were removed from the furnace at 1000° C. and directly placed on fire brick inside vacuum desiccators. The desiccators were immediately evacuated to <300 Pa and the metal oxide powders allowed to cool under vacuum until they were ready to be weighed and mixed. Immediately prior to experiments, 300 g of electrolyte was prepared by weighing and intimately mixing metal oxide powders. The depth of the molten oxide electrolyte (130) in the primary crucible (128) was about 30 mm at 1600° C.

High carbon, iron-carbon master alloys were prepared in 80 g ingots from Fe granules (99.98% pure, 1-2 mm, Alfa Aesar) and graphite powder (99.9995% pure, <75 μm, Alfa Aesar) by melting in alumina crucibles and bubbling with argon gas for 1 hour at 1600° C. in a vertical tube furnace under flowing 99.999% pure helium gas. Low carbon master alloys were prepared in the same procedure except substituting pieces of high-carbon master alloy in place of graphite. Immediately prior to each experiment, 10 g of master alloy was sectioned from the ingot, ground to remove any surface fouling, cleaned, dried, and placed inside the working electrode tube. The depth of the iron-carbon working electrode melt (138) was about 20 mm (at 1600° C.).

The working electrode steel (138) and molten oxide electrolyte (130) were placed in the cell assembly (126) and charged into the vertical tube furnace (110) along with the electrodes (148, 150). The furnace (110) was evacuated (<600 Pa) and purged three times with 99.999% pure helium gas which remained flowing at 15 L/h for the remainder of the experiment. For a working temperature of 1600° C., the set point of the furnace (110) was 1620° C. and was approached with a heating rate of 100° C./h. After reaching the working temperature, the counter and reference electrodes (148, 150) were slowly lowered into the molten oxide electrolyte (130). The system was allowed to soak for 2-3 h prior to any electrochemical testing.

The open circuit potential of the system was checked and usually reached equilibrium around −0.3 V vs. Mo. Uncompensated resistance was determined by electrochemical impedance spectroscopy, typically falling in the range of 2 to 8 ohms. Where applicable, all electrochemical testing utilized positive feedback iR compensation to account for the uncompensated resistance. Various electrochemical testing was conducted including impedance spectroscopy, chronopotentiometry, chronoamperometry, and square wave voltammetry. Reported cell potentials were corrected for ohmic drop.

The composition of the off gas from the furnace (110) was continuously monitored using a gas chromatograph (122) connected directly online with the furnace (110) so no gas sampling bombs were necessary. Off gas was sampled by opening and closing a series of valves to divert flow to the gas chromatograph (122) for a period of 2 minutes. This amount of time ensured the analytical columns (2 mL total volume) were maximally cleaned of any gases from previous sampling. Flow through the gas chromatograph (122) was monitored by a gas bubbler (160) installed on the exhaust of the instrument which also prevented back diffusion of atmospheric gases into the instrument. Afterwards, gas flow was restored to the canopy hood and the sample inside the gas chromatograph (122) was analyzed. The time required for analysis of each sample was 8.5 minutes. Gas concentrations could be determined down to a few parts per million by volume.

During experiments, in situ visual observations were possible through a 20 mm diameter quartz sighting window built into the cooling flange (118) of the furnace (110). A USB3.0 CMOS color camera (DFK 33UX178, The Imaging Source) equipment with a 5MP low distortion lens (FA5010A, The Imaging Source) and variable polarizing filter (#3, Gosky Optics) was used to record images and video through the sighting window.

### 1.4 Postmortem Characterization

After electrochemical testings, the furnace (110) was cooled from high temperature at a rate of 180° C./h under flowing helium. When the temperature reached near ambient, the cell assembly (126) and electrodes (148, 150) were removed from the furnace (110). The cell assembly (126) was deconstructed by sectioning with a water cooled cutting saw. The working electrode steel (138) was separated and mechanically ground to remove slag adhered to the surface. Samples of the working electrode ingot (138) were sectioned, cleaned with ethanol, dried, and mailed to the Steel Research Centre (McMaster University) to determine the carbon content by combustion analysis using a LECO CS 244 instrument and to determine oxygen content by inert gas fusion using a LECO TC 136 instrument. A portion of the working electrode ingot (138) was kept and characterized by X-ray diffraction (XRD), scanning electron microscopy (SEM), and energy dispersive X-ray spectroscopy (EDS).

Molten oxide electrolyte (130) was sectioned and pulverized in a puck mill. From the pulverized mixture, about 0.1 g of sample was fused with 2.0 g of lithium-metaborate-based flux mixture in a platinum crucible and digested in 5% nitric acid solution. Metals analysis was performed by inductively coupled plasma optical emission spectrometry (ICP-OES) using standard procedures. In some instances, the pulverized slag (130) was also analyzed by XRD, SEM, and EDS. Compositional analyses of counter electrodes, master alloys, and working electrodes were performed near total acid digestion (HNO₃+HF) followed by ICP-OES.

### 2. Results and Discussion

Design of the electrochemical cell (126) and electrolyte (130) was an iterative process where improvements were continually made based on experimental performance. Major challenges were encountered and overcome to arrive at the final version of the apparatus (126). However, only results on development of the electrorefining method are presented here as the apparatus is considered complete and performs well (experiments have been conducted up to 16 h in length).

Two types of experiments were performed to develop and test the present method and apparatus for electrorefining molten iron-carbon alloys. In the first type, molten iron-carbon alloys were refined under constant current or constant potential modulation to determine current efficiencies and energy requirements of the present process. In the second type, molten iron-carbon alloys were subject to rigorous electrochemical testing to measure kinetic parameters and determine mechanisms of the present refining process.

### 2.1 Current Efficiency and Energy Requirements for Electrorefining

Electrorefining trials were conducted at 1600° C. using carbon concentrations ranging from the eutectic (4.3 wt % C) to dilute alloys containing only 50 ppmw of carbon. Testing of high carbon alloys (e.g., >1 wt % C) was first necessary to establish proof-of-concept and determine reaction products. Afterwards electrorefining was extended to more and more dilute systems.

Cell potential transients and off-gas analyses during electrorefining Fe-3.78 wt % C alloy under constant current modulation are presented in FIG. 4. Results inform that (i) a low background level of carbon monoxide exists in the furnace atmosphere, (ii) carbon monoxide issues upon anodic polarization of the iron electrode, and (iii) carbon monoxide evolution discontinues and returns to background levels upon cessation of current. Gas evolution from the molten iron-carbon electrode was also confirmed visually during anodic polarization. As the only source of carbon in the furnace is from the iron-carbon working electrode (FIG. 3), electrorefining carbon from molten iron takes place. Postmortem combustion analysis of the solidified iron electrode confirmed that decarburburization took place from 3.78 wt % C to 0.84 wt % C with a current efficiency of 76%. Thus, electrorefining molten iron is demonstrated and viable.

Electrorefining trials were extended to lower levels of carbon, the results of which are tabulated in Table 1 below and presented graphically in FIG. 5A. Some of these trials were conducted under constant current modulation, while others were conducted under constant potential modulation. Current efficiency for decarburization, determined by post-mortem combustion analyses, tends to decrease as carbon concentration decreases, however it is important to note the current or potential modulation here was not optimized. Compositional analyses of the electrolyte post-mortem, by ICP-OES, determined the amount of iron present in the slag. Reduction in current efficiency due to loss of iron to the slag was estimated assuming all iron lost was in oxide form as iron(II) oxide. Moreover, the background level of FeO in the electrolyte (370 ppmw) was subtracted from that determined after refining.

Electrorefining of ultra-low carbon steel can thus be performed. In several trials, carbon concentration was reduced to a few hundred parts per million. The refining process can be extended to produce steels with no detectable levels of carbon (limit of combustion analyses is 1 ppmw of carbon). Iron lost to the slag can also be recovered by applying a cathodic potential or current hold after refining, thereby reducing the loss of iron by about 50% (54 ppmw C case).

TABLE 1
Summary of current efficiencies and parameters of electrorefining trials.

| | | | | Final | | Cell | | Cell | | | |
|---|---|---|---|---|---|---|---|---|---|---|---|
| Initial alloy | | Final alloy | | (FeO) | Refining | current | | potential | [C] | FeO | Cathode |
| composition | | composition | | (ppm) | time | (avg.) | | (avg.) | efficiency | efficiency^{a} | efficiency |
| 3.78 | wt % C | 0.84 | wt % C | 774 | 5.2 h | 396 | mA | 3.58 V | 76.3% | 5.3% | n.d. |
| 0.96 | wt % C | 0.35 | wt % C | 473 | 2.1 h | 200 | mA | 1.75 V | 62.5% | 5.5% | 90.6% |
| 0.22 | wt % C | 267 | ppm C | 937 | 4.0 h | 60.0 | mA | 0.81 V | 32.1% | 52.9% | n.d. |
| 726 | ppm C | 80 | ppm C | 760 | 2.0 h | 46.5 | mA | 0.09 V | 29.4% | 62.5% | n.d. |
| 54 | ppm C | <1 | ppm C | 911 | 3.1 h | 77.8 | mA | 0.35 V | 1-2% | 50.1% | n.d. |

^{a}Considering initial (FeO) = 370 ppm. n.d. = not determined

Typically, producing such low carbon steels by conventional means are challenged by loss of iron to the slag (as oxide) and high oxygen levels in liquid steel. Oxygen content of steel was monitored after refining (by LECO), as presented in FIG. 5B, and it was discovered that oxygen levels remain exceedingly low despite low carbon levels achieved and high current densities. The process can thus perform decarburization without significantly oxidizing the steel bath.

Recovery of by-product metal can also be performed at the counter electrode. Postmortem SEM/EDS characterization of the counter electrode, shown in FIG. 6, proved a concentration of silicon on the surface, while XRD proved silicon was produced in metallic form which alloys with molybdenum forming intermetallic compounds. To determine the current efficiency at the counter electrode, it was digested in a mixture of hydrofluoric and nitric acids which attack silicon. ICP-OES analyses proved that silicon is deposited with a current efficiency of 91%.

In terms of energy, the average cell potentials and current efficiencies were used to determine the energy requirements (kWh/t) for refining. The results are presented in Table 2 below. While the specific energy consumption in terms of kWh per tonne of feed is reduced as the carbon concentration decreases (owing to the decreasing concentration of carbon), the specific energy consumption in terms of kWh per kilogram of carbon remains more consistent. Overall, the energy consumption for refining is low, while high value is added to products containing such low levels of carbon. Simultaneously, the same amount of energy is used to produce some amounts of silicon metal on the counter electrode. The energy consumption for silicon by-production is also low and offsets the cost of refining further.

TABLE 2
Summary of energy requirements of electrorefining trials.

| | | | | | | | Specific energy | | | |
|---|---|---|---|---|---|---|---|---|---|---|
| | | | | Average | Anode | Cathode | consumption | | By- | By- |
| Starting | | Final | | cell | current | current | kWh/kg | kWh/t | product Si | product Si |
| composition | | composition | | potential | efficiency | efficiency | C | feed | (kg/t feed) | (kWh/t Si) |
| 3.78 | wt % C | 0.84 | wt % C | 3.58 V | 76.3% | n.d. | 20.9 | 790.0 | n.d. | n.d. |
| 0.96 | wt % C | 0.35 | wt % | 1.75 V | 62.5% | 91% | 12.5 | 120.0 | 16.3 | 7,340 |
| 0.22 | wt % C | 267 | ppm C | 0.81 V | 32.1% | n.d. | 11.3 | 24.8 | n.d. | n.d. |
| 726 | ppm C | 80 | ppm C | 0.09 V | 29.4% | n.d. | 1.4 | 1.0 | n.d. | n.d. |
| 54 | ppm C | <1 | ppm C | 0.35 V | 1.0% | n.d. | 156.2 | 8.4 | n.d. | n.d. |

n.d. = not determined

### 2.2 Kinetics and Mechanisms of Electrorefining

Given that electrorefining of molten steel has been proven and promising for refining ultra-low carbon steels, the kinetics and mechanisms of electrorefining were investigated electrochemically. The aim here was to measure fundamental kinetic and thermodynamic parameters for different reactions in order to optimize the potential or current modulation for maintaining high current efficiency for carbon oxidation and minimizing loss of iron. Furthermore, electrochemical testing was performed at 1600° C., 1650° C., and 1700° C. to obtain the temperature dependence of parameters to allow for some optimization of temperature in the process as well.

Steady-state current-potential curves were recorded for a number of different iron-carbon alloys as presented in FIGS. 7A and 7B. The linear dependency of the logarithm of current density on potential confirms an electrochemical reaction under charge transfer control takes place. Linear portions of the curves were fit to the Tafel equation according to

$$η = \frac{R T}{α n F} ln i - \frac{R T}{α n F} ln {i}_{0}$$

where η is the overpotential in V, R is the gas constant, T is the absolute temperature, a is the transfer coefficient, n is the number of electrons exchanged, i₀ is the exchange current, and i is the current (A). The fact that these alloys all share the same slope means the transfer coefficient and number of electrons does not change. The exchange current (i.e., the intercept), however, is affected by the carbon concentration. A test of the dependence of the exchange current on the concentration according to the equation

i₀=nFk⁰C_{Ox}^{*(1-α)}C_{Red}^{*α}

revealed that carbon is directly involved in the electrochemical process and that the value of the transfer coefficient was 0.56. Thus, based on the slopes of the lines in FIGS. 7A and 7B, the number of electrons exchanged in the rate determining step was found to be close to unity.

Electrochemical impedance spectroscopy performed at the rest potential revealed a distinct effect of carbon concentration, as presented in FIGS. 7A and 7B. Qualitatively, the impedance of the system decreased as carbon concentration increased. This means the resistance for a certain electrochemical reaction to occur is reduced in the presence of carbon. Quantitatively, it was found the exchange current was dependent on the carbon concentration with a transfer coefficient close to 0.65. Thus, it appears at least two reactions are present involving or influenced by carbon.

Rates of carbon monoxide gas generation observed in different electrorefining trials at constant current density provided information on the kinetics of the step prior to gas release. As shown in FIG. 9, generation of carbon monoxide gas obeys first order kinetics by virtue of the linear dependence of its concentration against time. Kinetic rate constants are determined by the slopes of the lines and reveal that the rate constant is constant for different carbon concentrations and for the different current densities employed.

Based on data obtained, the following scheme of reactions was proposed which satisfy all observations.

(O²⁻)+[C]═C(O⁻)_{ads}+e⁻

C(O⁻)_{ads}═C(O)_{ads}+e⁻

C(O)_{ads}═CO_{gas}

One of the steps in the discharge of the oxygen ion is rate determining while one proceeds much faster. Also, it fits the observations that the desorption of carbon monoxide gas is chemical in nature and does not appear to depend on current density.

In terms of modelling and process control, the proven relations presented in FIGS. 7A, 7B, 8A and 8B provide an opportunity to sense or measure the concentration of carbon electrochemically without the need for off gas analysis, sampling, or other such techniques.

Although the present invention has been described hereinabove by way of specific embodiments thereof, it can be modified, without departing from the spirit and nature of the subject invention defined in the appended claims.

1. A method for electrorefining a ferrous molten metal that includes iron and impurities, the method comprising:
providing the ferrous molten metal to be refined in a treatment ladle with a molten electrolyte on top of the ferrous molten metal so as to form a metal-electrolyte interface;
contacting an electrode connection made of a first electronically conductive material remaining in a solid form in, and being substantially inert to, the ferrous molten metal with the ferrous molten metal for electronic conduction therewith;
contacting a counter electrode made of a second electronically conductive material remaining in a solid form in, and being substantially inert to, the molten electrolyte with the molten electrolyte so as to form an electrolyte-counter electrode interface; and
during electrorefining operations:
supplying an electromotive force between the electrode connection and the counter electrode so as to induce electrochemical reactions to occur at both the metal-electrolyte interface and the electrolyte-counter electrode interface; and
producing a ferrous molten metal depleted of the impurities.

2. The method of claim 1, wherein a reaction by-product is recovered at the counter electrode during the electrorefining operations.

3. The method of claim 1 or 2, wherein the impurities comprise carbon.

4. The method of any one of claims 1 to 3, wherein the impurities comprise sulfur.

5. The method of any one of claims 1 to 4, wherein the impurities comprise oxygen.

6. The method of any one of claims 1 to 5, wherein the impurities comprise phosphorus.

7. The method of any one of claims 1 to 6, wherein the ferrous molten metal comprises molten steel.

8. The method of any one of claims 1 to 6, wherein the ferrous molten metal comprises a molten iron-alloy.

9. The method of any one of claims 2 to 8, wherein the reaction by-product comprises silicon.

10. The method of any one of claims 2 to 9, wherein the reaction by-product comprises ferrosilicon.

11. The method of any one of claims 2 to 8, wherein the reaction by-product comprises aluminum.

12. The method of any one of claims 3 to 11, wherein the impurities content of the ferrous molten metal prior to the electrorefining operations is between about 0.01% and about 10%, between about 0.05% and about 5%, or between about 0.1% and about 1%.

13. The method of any one of claims 3 to 12, wherein the impurities content of the ferrous molten metal prior to the electrorefining operations is between about 40 ppmw and about 100 ppmw, between about 50 ppmw and about 90 ppmw, or between about 60 ppmw and about 80 ppmw.

14. The method of any one of claims 3 to 13, wherein the impurities content of the ferrous molten metal depleted of the impurities after the electrorefining operations have been performed is below about 100 ppmw, below about 75 ppmw, below about 50 ppmw or below about 10 ppmw.

15. The method of any one of claims 1 to 14, wherein the connection material has a melting temperature higher than about 1600° C., higher than about 1700° C., or higher than about 1800° C.

16. The method of any one of claims 1 to 15, wherein the first electronically conductive material is an electronically conducting ceramic.

17. The method of any one of claims 1 to 16, wherein the first electronically conductive material comprises a refractory metal boride.

18. The method of any one of claims 1 to 17, wherein the first electronically conductive material comprises zirconium diboride (ZrB₂).

19. The method of any one of claims 1 to 18, wherein the first electronically conductive material comprises titanium diboride (TiB₂).

20. The method of any one of claims 1 to 19, wherein the first electronically conductive material comprises hafnium diboride (HfB₂).

21. The method of any one of claims 1 to 20, wherein the first electronically conductive material comprises tantalum diboride (TaB₂).

22. The method of any one of claims 1 to 21, wherein the first electronically conductive material comprises niobium diboride (NbB₂).

23. The method of any one of claims 1 to 22, wherein the first electronically conductive material comprises vanadium diboride (VB₂).

24. The method of any one of claims 1 to 23, wherein the first electronically conductive material comprises chromium boride (CrB).

25. The method of any one of claims 1 to 24, wherein the first electronically conductive material comprises chromium diboride (CrB₂).

26. The method of any one of claims 1 to 25, wherein the first electronically conductive material comprises a molybdenum boride.

27. The method of any one of claims 1 to 26, wherein the first electronically conductive material comprises a tungsten boride.

28. The method of any one of claims 18 to 27, wherein the first electronically conductive material comprises between about 40% v/v and about 100% v/v, between about 50% v/v and about 95% v/v, or between about 60% v/v and about 90% v/v of zirconium diboride.

29. The method of any one of claims 19 to 28, wherein the first electronically conductive material comprises between about 40% v/v and about 100% v/v, between about 50% v/v and about 95% v/v, or between about 60% v/v and about 90% v/v of titanium diboride.

30. The method of any one of claims 20 to 29, wherein the first electronically conductive material comprises between about 40% v/v and about 100% v/v, between about 50% v/v and about 95% v/v, or between about 60% v/v and about 90% v/v of hafnium diboride.

31. The method of any one of claims 21 to 30, wherein the first electronically conductive material comprises between about 40% v/v and about 100% v/v, between about 50% v/v and about 95% v/v, or between about 60% v/v and about 90% v/v of tantalum diboride.

32. The method of any one of claims 22 to 31, wherein the first electronically conductive material comprises between about 40% v/v and about 100% v/v, between about 50% v/v and about 95% v/v, or between about 60% v/v and about 90% v/v of niobium diboride.

33. The method of any one of claims 23 to 32, wherein the first electronically conductive material comprises between about 40% v/v and about 100% v/v, between about 50% v/v and about 95% v/v, or between about 60% v/v and about 90% v/v of vanadium diboride.

34. The method of any one of claims 24 to 33, wherein the electronically conductive material comprises between about 40% v/v and about 100% v/v, between about 50% v/v and about 95% v/v, or between about 60% v/v and about 90% v/v of chromium boride.

35. The method of any one of claims 25 to 34, wherein the first electronically conductive material comprises between about 40% v/v and about 100% v/v, between about 50% v/v and about 95% v/v, or between about 60% v/v and about 90% v/v of chromium diboride.

36. The method of any one of claims 26 to 35, wherein the first electronically conductive material comprises between about 40% v/v and about 100% v/v, between about 50% v/v and about 95% v/v, or between about 60% v/v and about 90% v/v of the molybdenum boride.

37. The method of any one of claims 27 to 36, wherein the first electronically conductive material comprises between about 40% v/v and about 100% v/v, between about 50% v/v and about 95% v/v, or between about 60% v/v and about 90% v/v of the tungsten boride.

38. The method of any one of claims 1 to 37, comprising submerging the electrode connection into the ferrous molten metal for electronic conduction therewith.

39. The method of any one of claims 1 to 38, comprising protecting the electrode connection from the ferrous molten metal using a protective sheath.

40. The method of any one of claims 1 to 39, comprising providing the electrode connection to extend from the treatment ladle.

41. The method of any one of claims 1 to 40, comprising contacting a plurality of electrode connections with the ferrous molten metal for electronic conduction therewith.

42. The method of any one of claims 1 to 41, wherein the electrode connection is positioned opposite to the metal-electrolyte interface.

43. The method of any one of claims 1 to 42, comprising promoting electro-vortex mixing of the ferrous molten metal.

44. The method of any one of claims 1 to 43, wherein the second electronically conductive material has a melting temperature higher than about 1600° C., or higher than about 1700° C.

45. The method of any one of claims 1 to 44, wherein the second electronically conductive material has a melting temperature higher than about 1800° C.

46. The method of any one of claims 1 to 45, wherein the second electronically conductive material is resistant to an oxidative atmosphere.

47. The method of any one of claims 2 to 46, wherein the second electronically conductive material is inert to the reaction by-product.

48. The method of any one of claims 1 to 47, wherein the second electronically conductive material comprises molybdenum (Mo), graphite (C), carbon (C), tantalum (Ta), niobium (Nb), chromium (Cr), a platinum group metal, a refractory metal boride(s), zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof.

49. The method of claim 48, wherein the counter electrode comprises between about 40% v/v and about 100% v/v, between about 50% v/v and about 95% v/v, or between about 60% v/v and about 90% v/v of the second electronically conductive material.

50. The method of any one of claims 1 to 49, comprising submerging the counter electrode into the molten electrolyte.

51. The method of any one of claims 2 to 50, wherein an alloy is formed with the counter electrode and the reaction by-product.

52. The method of any one of claims 1 to 51, comprising protecting the counter electrode from the molten electrolyte.

53. The method of claim 52, wherein the protection is provided by a protective sheath made of a ceramic material.

54. The method of claim 52, wherein the protection is provided by a protective sheath made of a material comprising graphite.

55. The method of any one of claims 1 to 54, comprising providing the counter electrode to extend from the treatment ladle so as to be in contact with the molten electrolyte.

56. The method of any one of claims 1 to 55, comprising contacting a plurality of counter electrodes with the molten electrolyte for forming the electrolyte-counter electrode interface.

57. The method of any one of claims 1 to 56, comprising positioning the counter electrode opposite to the metal-electrolyte interface.

58. The method of any one of claims 2 to 57, comprising collecting the reaction by-product at a by-product collection area of the counter electrode facing the metal-electrolyte interface.

59. The method of any one of claims 1 to 58, wherein the impurities and the molten electrolyte have a chemical affinity.

60. The method of any one of claims 1 to 59, wherein the molten electrolyte has a melting temperature higher than about 1300° C., higher than about 1400° C., or higher than about 1500° C.

61. The method of any one of claims 2 to 60, wherein the molten electrolyte and the reaction by-product have a chemical affinity.

62. The method of any one of claims 1 to 61, wherein the molten electrolyte has a density lower than the density of the ferrous molten metal.

63. The method of any one of claims 2 to 62, wherein the molten electrolyte has a density higher than the density of the reaction by-product.

64. The method of any one of claims 1 to 63, wherein the molten electrolyte has a density of between about 2 g/cm³ and about 7 g/cm³, of between about 2.2 g/cm³ and about 6 g/cm³, or of between about 2.5 g/cm³ and about 5.5 g/cm³.

65. The method of any one of claims 1 to 64, wherein the molten electrolyte has a viscosity of between about 0.1 poise and about 5 poise, between about 0.5 poise and about 4 poise, or between about 1 poise and about 3 poise.

66. The method of any one of claims 1 to 65, wherein the molten electrolyte has a vapour pressure below about 0.01 atm, below about 0.001 atm, or below 0.0001 atm.

67. The method of any one of claims 1 to 66, wherein the counter electrode is provided at a distance from the metal-electrolyte interface.

68. The method of claim 67, wherein the distance is between about 1 cm and about 50 cm, between about 2 cm and about 20 cm, or between about 2 cm and about 10 cm.

69. The method of any one of claims 1 to 68, wherein the thickness of the ferrous molten metal is between about 2 cm and about 300 cm, between about 10 cm and about 200 cm, or between about 50 cm and about 150 cm.

70. The method of any one of claims 1 to 69, wherein the thickness of the molten electrolyte is between about 2 cm and about 200 cm, between about 5 cm and about 100 cm, or between about 5 cm and about 50 cm.

71. The method of any one of claims 1 to 70, wherein the thickness of the molten electrolyte is between about 1% and about 30%, between about 4% and about 20%, or between about 5% and about 15% the thickness of the ferrous molten metal.

72. The method of any one of claims 1 to 71, wherein the molten electrolyte is an ionic conductor for allowing flow of ions therethrough.

73. The method of any one of claims 1 to 72, wherein the molten electrolyte comprises an oxide.

74. The method of claim 73, wherein the oxide comprises calcium oxide (CaO).

75. The method of claim 73 or 74, wherein the oxide comprises aluminium oxide (Al₂O₃).

76. The method any one of claims 73 to 75, wherein the oxide comprises silicon dioxide (SiO₂).

77. The method any one of claims 73 to 76, wherein the oxide comprises magnesium oxide (MgO).

78. The method of any one of claims 1 to 77, wherein the molten electrolyte comprises a sulfide.

79. The method of any one of claims 1 to 78, wherein the molten electrolyte comprises a chloride.

80. The method of any one of claims 1 to 79, wherein the molten electrolyte further comprises a fluoride.

81. The method of any one of claims 1 to 80, wherein the molten electrolyte is a slag formed on top of the ferrous molten metal.

82. The method of any one of claims 1 to 81, comprising providing one of: a current or a potential to the electrode connection and the counter electrode to be modulated at the metal-electrolyte interface.

83. The method of claim 82, comprising modulating potential to supply the electromotive force between the electrode connection and the counter electrode.

84. The method of claim 83, wherein the potential is direct potential.

85. The method of claim 83, wherein the potential is alternating potential.

86. The method of claim 83, wherein the potential is a combination of direct potential and alternating potential.

87. The method of claim 82, comprising modulating current to supply the electromotive force between the electrode connection and the counter electrode.

88. The method of claim 87, wherein the current is direct current.

89. The method of claim 87, wherein the current is alternating current.

90. The method of claim 87, wherein the current is a combination of direct current and alternating current.

91. The method of any one of claims 83 to 86, wherein the potential is between about 0.01 V and about 30 V, between about 0.1 V and about 10 V, or between about 0.5 V and about 5 V.

92. The method of any one of claims 87 to 90, wherein the current is between about 1 mA/cm² and about 5000 mA/cm², between about 10 mA/cm² and about 1000 mA/cm², or between about 50 mA/cm² and about 500 mA/cm².

93. The method of any one of claims 1 to 92, comprising contacting an auxiliary electrode made of a third electronically conductive material with the molten electrolyte for electrochemically measuring the impurities content.

94. The method of claim 93, wherein the auxiliary electrode is submerged into the molten electrode to form an electrolyte-auxiliary electrode interface.

95. The method of claim 93 or 94, wherein the third electronically conductive material is inert to the molten electrolyte.

96. The method of claim 95, wherein the third electronically conductive material remains in a solid form in the molten electrolyte.

97. The method of claim 95 or 96, wherein the third electronically conductive material comprises molybdenum (Mo), graphite (C), carbon (C), tantalum (Ta), niobium (Nb), chromium (Cr), a platinum group metal, a refractory metal boride(s), zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof.

98. The method of any one of claims 93 to 97, wherein the auxiliary electrode is a reference electrode with a determined thermodynamic electrode potential.

99. The method of any one of claims 93 to 98, comprising contacting a plurality of auxiliary electrodes with the molten electrolyte.

100. The method of any one of claims 1 to 99, wherein the impurities are selectively reacted and removed from the ferrous molten metal to produce the ferrous molten metal depleted of the impurities.

101. The method of any one of claims 1 to 100, wherein the electromotive force is supplied to the electrode connection and the counter electrode for a retention time sufficient to reduce the impurities content.

102. The method of claim 101, wherein the retention time is between about 0.1 hour and about 10 hours, between about 0.5 hour and about 5 hours, or between about 0.5 hour and about 2 hours.

103. The method of any one of claims 1 to 102, comprising monitoring sensitive electrochemical signals of at least one of: the ferrous molten metal or the molten electrolyte during the electrorefining operations.

104. The method of claim 103, wherein the electrochemical signals are determined by at least one of: potential, polarization characteristics, or impedance spectroscopy.

105. The method of claim 103 or 104, comprising adjusting the electromotive force relative to the electrochemical signals monitored.

106. The method of claim 105, wherein adjusting the electromotive force is performed in real time.

107. The method of any one of claims 1 to 106, comprising adjusting the electromotive force relative to the impurities content of the ferrous molten metal.

108. The method of any one of claims 2 to 107, comprising adjusting the electromotive force relative to the reaction by-product content of the molten electrolyte.

109. The method of any one of claims 1 to 108, wherein the electromotive force is supplied relative to the composition of the ferrous molten metal.

110. The method of any one of claims 1 to 109, wherein the electromotive force is supplied relative to the composition of the impurities.

111. The method of any one of claims 1 to 110, wherein the electromotive force is supplied relative to a stage of the electrorefining operations.

112. The method of any one of claims 1 to 111, wherein the electromotive force is supplied relative to the temperature of the ferrous molten metal.

113. The method of any one of claims 1 to 112, comprising electrochemically recovering ferrous molten metal products transferred to the molten electrolyte during the electrorefining operations.

114. The method of claim 113, wherein the recovering is performed for the ferrous molten metal that has been oxidized inadvertently during the electrorefining operations.

115. The method of claim 113, wherein the recovering is performed for the ferrous molten metal that has been dispersed as droplets or as an emulsion through the molten electrolyte during the electrorefining operations.

116. The method of any one of claims 1 to 115, wherein energy consumed during the electrorefining operations is between about 1 kWh/kg of impurities and about 50 kWh/kg of impurities, between about 5 kWh/kg of impurities and about 40 kWh/kg of impurities, or between about 10 kWh/kg of impurities and about 20 kWh/kg of impurities.

117. The method of any one of claims 3 to 116, wherein the energy consumed during the electrorefining operations is between about 1 kWh/kg of carbon and about 50 kWh/kg of carbon, between about 5 kWh/kg of carbon and about 40 kWh/kg of carbon, or between about 10 kWh/kg of carbon and about 20 kWh/kg of carbon.

118. The method of any one of claims 1 to 117, wherein the energy consumed during the electrorefining operations is between about 1 kWh/t of ferrous molten metal and about 2000 kWh/t of ferrous molten metal, between about 100 kWh/t of ferrous molten metal and about 1500 kWh/t of ferrous molten metal, or between about 500 kWh/t of ferrous molten metal and about 1000 kWh/t of ferrous molten metal.

119. The method of any one of claims 7 to 118, wherein the energy consumed during the electrorefining operations is between about 1 kWh/t of molten steel and about 2000 kWh/t of molten steel, between about 100 kWh/t of molten steel and about 1500 kWh/t of molten steel, or between about 500 kWh/t of molten steel and about 1000 kWh/t of molten steel.

120. The method of any one of claims 1 to 119, wherein the electrorefining operations are operated so that the impurities content of the ferrous molten metal depleted of the impurities is between about 0.01% and about 80%, between about 0.1% and about 50%, or between about 1% and about 10% the impurities content of the ferrous molten metal.

121. The method of any one of claims 7 to 120, wherein the electrorefining operations are operated so that the impurities content of the ferrous molten metal depleted of the impurities is below a threshold so as to be suitable for the production of an ultra-low carbon steel.

122. The method of claims 8 to 120, wherein the electrorefining operations are operated so that the impurities content of the ferrous molten metal depleted of the impurities is below a threshold so as to be suitable for the production of a stainless steel.

123. The method of any one of claims 1 to 122, wherein the electrorefining operations are performed under an oxidizing atmosphere.

124. The method of any one of claims 1 to 122, wherein the electrorefining operations are performed under an inert atmosphere.

125. The method of any one of claims 1 to 122, wherein the electrorefining operations are performed under a vacuum atmosphere.

126. An apparatus for performing the method according to any one of claims 1 to 125.

127. An apparatus for electrorefining a ferrous molten metal that includes iron and impurities, the ferrous molten metal being contained in a treatment ladle and being covered by a molten electrolyte so as to form a metal-electrolyte interface, the apparatus comprising:
an electrode connection made of a first electronically conductive material remaining in a solid form in, and being substantially inert to, the ferrous molten metal, to be in contact with the ferrous molten metal for electronic conduction therewith;
a counter electrode made of a second electronically conductive material remaining in a solid form in, and being substantially inert to, the molten electrolyte, to be in contact with the molten electrolyte for forming an electrolyte-counter electrode interface;
a power supply in electrical communication with both the electrode connection and the counter electrode for imposing an electromotive force between the electrode connection and the counter electrode so as to induce electrochemical reactions to occur at both the metal-electrolyte interface and the electrolyte-counter electrode interface, thereby producing a ferrous molten metal depleted of the impurities.

128. The apparatus of claim 127, wherein the impurities comprise carbon.

129. The apparatus of claim 127 or 128, wherein the impurities comprise sulfur.

130. The apparatus of any one of claims 127 to 129, wherein the impurities comprise oxygen.

131. The apparatus of any one of claims 127 to 130, wherein the impurities comprise phosphorus.

132. The apparatus of any one of claims 127 to 131, wherein the ferrous molten metal comprises molten steel.

133. The apparatus of any one of claims 127 to 131, wherein the ferrous molten metal comprises a molten iron-alloy.

134. The apparatus of any one of claims 127 to 133, wherein the first electronically conductive material has a melting temperature higher than about 1600° C., higher than about 1700° C., or higher than about 1800° C.

135. The apparatus of any one of claims 127 to 134, wherein the first electronically conductive material is an electronically conducting ceramic.

136. The apparatus of any one of claims 127 to 135, wherein the first electronically conductive material comprises a refractory metal boride.

137. The apparatus of any one of claims 127 to 136, wherein the first electronically conductive material comprises zirconium diboride (ZrB₂).

138. The apparatus of any one of claims 127 to 137, wherein the first electronically conductive material comprises titanium diboride (TiB₂).

139. The apparatus of any one of claims 127 to 138, wherein the first electronically conductive material comprises hafnium diboride (HfB₂).

140. The apparatus of any one of claims 127 to 139, wherein the first electronically conductive material comprises tantalum diboride (TaB₂).

141. The apparatus of any one of claims 127 to 140, wherein the first electronically conductive material comprises niobium diboride (NbB₂).

142. The apparatus of any one of claims 127 to 141, wherein the first electronically conductive material comprises vanadium diboride (VB₂).

143. The apparatus of any one of claims 127 to 142, wherein the first electronically conductive material comprises chromium boride (CrB).

144. The apparatus of any one of claims 127 to 143, wherein the first electronically conductive material comprises chromium diboride (CrB₂).

145. The apparatus of any one of claims 127 to 144, wherein the first electronically conductive material comprises a molybdenum boride.

146. The apparatus of any one of claims 127 to 145, wherein the first electronically conductive material comprises a tungsten boride.

147. The apparatus of any one of claims 137 to 146, wherein the first electronically conductive material comprises between about 40% v/v and about 100% v/v, between about 50% v/v and about 95% v/v, or between about 60% v/v and about 90% v/v of zirconium diboride.

148. The apparatus of any one of claims 138 to 147, wherein the first electronically conductive material comprises between about 40% v/v and about 100% v/v, between about 50% v/v and about 95% v/v, or between about 60% v/v and about 90% v/v of titanium diboride.

149. The apparatus of any one of claims 139 to 148, wherein the first electronically conductive material comprises between about 40% v/v and about 100% v/v, between about 50% v/v and about 95% v/v, or between about 60% v/v and about 90% v/v of hafnium diboride.

150. The apparatus of any one of claims 140 to 149, wherein the first electronically conductive material comprises between about 40% v/v and about 100% v/v, between about 50% v/v and about 95% v/v, or between about 60% v/v and about 90% v/v of tantalum diboride.

151. The apparatus of any one of claims 141 to 150, wherein the first electronically conductive material comprises between about 40% v/v and about 100% v/v, between about 50% v/v and about 95% v/v, or between about 60% v/v and about 90% v/v of niobium diboride.

152. The apparatus of any one of claims 142 to 151, wherein the first electronically conductive material comprises between about 40% v/v and about 100% v/v, between about 50% v/v and about 95% v/v, or between about 60% v/v and about 90% v/v of vanadium diboride.

153. The apparatus of any one of claims 143 to 152, wherein the first electronically conductive material comprises between about 40% v/v and about 100% v/v, between about 50% v/v and about 95% v/v, or between about 60% v/v and about 90% v/v of chromium boride.

154. The apparatus of any one of claims 144 to 153, wherein the first electronically conductive material comprises between about 40% v/v and about 100% v/v, between about 50% v/v and about 95% v/v, or between about 60% v/v and about 90% v/v of chromium diboride.

155. The apparatus of any one of claims 145 to 154, wherein the first electronically conductive material comprises between about 40% v/v and about 100% v/v, between about 50% v/v and about 95% v/v, or between about 60% v/v and about 90% v/v of the molybdenum boride.

156. The apparatus of any one of claims 146 to 155, wherein the first electronically conductive material comprises between about 40% v/v and about 100% v/v, between about 50% v/v and about 95% v/v, or between about 60% v/v and about 90% v/v of the tungsten boride.

157. The apparatus of any one of claims 127 to 156, wherein the first electronically conductive material is configured to be submerged into the ferrous molten metal for electronic conduction therewith.

158. The apparatus of any one of claims 127 to 157, comprising an electrode connection wire electrically connecting the electrode connection to the power supply.

159. The apparatus of claim 158, comprising a protective sheath for receiving the electrode connection and the electrode connection wire therein.

160. The apparatus of any one of claims 127 to 159, wherein the treatment ladle comprises a bottom and a peripheral wall upwardly extending therefrom, the electrode connection extending from at least one of: the bottom or the peripheral wall of the treatment ladle.

161. The apparatus of any one of claims 127 to 160, comprising a plurality of electrode connections configured to be in contact with the ferrous molten metal for electronic conduction therewith.

162. The apparatus of any one of claims 127 to 161, wherein the electrode connection is positioned opposite to the metal-electrolyte interface.

163. The apparatus of any one of claims 127 to 162, wherein the surface area of the electrode connection is less than the surface area of the metal-electrolyte interface to promote electro-vortex mixing of the ferrous molten metal.

164. The apparatus of claim 163, wherein the surface area of the electrode connection is between about 0.1% and about 95%, between about 0.5% and about 85%, or between about 1% and about 70% the surface area of the metal-electrolyte interface.

165. The apparatus of any one of claims 127 to 164, wherein the second electronically conductive material has a melting temperature higher than about 1600° C., or higher than about 1700° C.

166. The apparatus of any one of claims 127 to 165, wherein the second electronically conductive material has a melting temperature higher than about 1800° C.

167. The apparatus of any one of claims 127 to 166, wherein the second electronically conductive material is resistant to an oxidative atmosphere.

168. The apparatus of any one of claims 127 to 167, wherein a reaction by-product is formed at the counter electrode, the second electronically conductive material being substantially inert to the reaction by-product.

169. The apparatus of any one of claims 127 to 168, wherein the second electronically conductive material comprises molybdenum (Mo), graphite (C), carbon (C), tantalum (Ta), niobium (Nb), chromium (Cr), a platinum group metal, a refractory metal boride(s), zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof.

170. The apparatus of claim 169, wherein the counter electrode comprises between about 40% v/v and about 100% v/v, between about 50% v/v and about 95% v/v, or between about 60% v/v and about 90% v/v of the second electronically conductive material.

171. The apparatus of any one of claims 127 to 170, wherein the counter electrode is configured to be submerged into the molten electrolyte.

172. The apparatus of any one of claims 127 to 171, wherein the surface area of the counter electrode is between about 10% and about 200%, between about 20% and about 100%, or between about 30% and about 80% the surface area of the metal-electrolyte interface.

173. The apparatus of any one of claims 127 to 172, comprising a counter electrode wire electrically connecting the counter electrode to the power supply.

174. The apparatus of claim 173, comprising a protective sheath for receiving the counter electrode and the counter electrode wire therein.

175. The apparatus of claim 174, wherein the protective sheath is made of a ceramic material.

176. The apparatus of claim 174, wherein the protective sheath is made of a material comprising graphite.

177. The apparatus of any one of claims 127 to 176, wherein the counter electrode extends from the treatment ladle so as to be in contact with the molten electrolyte.

178. The apparatus of any one of claims 127 to 177, comprising a plurality of counter electrodes configured to be in contact with the molten electrolyte.

179. The apparatus of any one of claims 127 to 178, wherein the counter electrode is positioned opposite to the metal-electrolyte interface.

180. The apparatus of claim 168, wherein the counter electrode is configured to collect the reaction by-product.

181. The apparatus of claim 180, wherein the counter electrode comprises a by-product collection area facing the metal-electrolyte interface to collect the reaction by-product produced during the electrorefining operations.

182. The apparatus of any one of claims 127 to 181, wherein the counter electrode is located at a distance from the metal-electrolyte interface.

183. The apparatus of claim 182, wherein the distance is between about 1 cm and about 30 cm, between about 2 cm and about 20 cm, or between about 5 cm and about 10 cm.

184. The apparatus of any one of claims 127 to 183, wherein the power supply is configured to provide one of: a current or a potential to be modulated at the metal-electrolyte interface.

185. The apparatus of any one of claims 127 to 184, wherein the power supply is configured to modulate potential.

186. The apparatus of claim 185, wherein the potential is direct potential.

187. The apparatus of claim 185, wherein the potential is alternating potential.

188. The apparatus of claim 185, wherein the potential is a combination of direct potential and alternating potential.

189. The apparatus of any one of claims 127 to 184, wherein the power supply is configured to modulate current.

190. The apparatus of claim 189, wherein the current is direct current.

191. The apparatus of claim 189, wherein the current is alternating current.

192. The apparatus of claim 189, wherein the current is a combination of direct current and alternating current.

193. The apparatus of any one of claims 127 to 192, comprising an auxiliary electrode made of a third electronically conductive material configured to be in contact with the molten electrolyte for electrochemically measuring the impurities content of the ferrous molten metal.

194. The apparatus of claim 193, wherein the auxiliary electrode is configured to be submerged into the molten electrode.

195. The apparatus of claim 193 or 194, wherein the third electronically conductive material remains in a solid form in, and being substantially inert to, the molten electrolyte.

196. The apparatus of claim 195, wherein the third electronically conductive material comprises molybdenum (Mo), graphite (C), carbon (C), tantalum (Ta), niobium (Nb), chromium (Cr), a platinum group metal, a refractory metal boride(s), zirconium diboride (ZrB₂), titanium diboride (TiB₂), hafnium diboride (HfB₂), tantalum diboride (TaB₂), niobium diboride (NbB₂), vanadium diboride (VB₂), chromium boride (CrB), chromium diboride (CrB₂), molybdenum boride, tungsten boride, or any combination thereof.

197. The apparatus of any one of claims 193 to 196, comprising a plurality of auxiliary electrodes.

198. A method for electrorefining a ferrous molten metal that includes iron and impurities, the method comprising:
providing the ferrous molten metal to be refined in a treatment ladle with an electrolyte in contact with the ferrous molten metal so as to form a metal-electrolyte interface;
contacting an electrode connection made of a first electronically conductive material remaining in a solid form in, and being substantially inert to, the ferrous molten metal with the ferrous molten metal for electronic conduction therewith;
contacting a counter electrode made of second electronically conductive material remaining in a solid form in, and being substantially inert to, the electrolyte with the electrolyte for forming an electrolyte-counter electrode interface; and
during electrorefining operations:
supplying an electromotive force between the electrode connection and the counter electrode so as to induce electrochemical reactions to occur at both the metal-electrolyte interface and the electrolyte-counter electrode interface; and
producing a ferrous molten metal depleted of the impurities.

199. The method of claim 198, wherein the electrolyte is provided in a molten form on top of the ferrous molten metal.

200. The method of claim 198, wherein the molten electrolyte is a slag formed on top of the ferrous molten metal.

201. The method of any one of claims 198 to 200, wherein the counter electrode is submerged, at least in part, in the molten electrolyte.

202. The method of claim 198, wherein the electrolyte is provided in a solid form.

203. The method of claim 202, comprising displacing the solid electrolyte in the molten electrolyte during the electrorefining operations to collect the impurities.

204. An apparatus for performing the method according to any one of claims 198 to 203, the apparatus being as defined in any one of claims 127 to 197.

205. A method for electrorefining a molten steel that includes carbon impurities, the method comprising:
providing the molten steel to be refined in a treatment ladle with an ionic slag formed on top of the molten steel so as to form a steel-slag interface;
contacting an electrode connection made of a first electronically conductive material remaining in a solid form in, and being substantially inert to, the molten steel with the molten steel for electronic conduction therewith;
contacting a counter electrode made of a second electronically conductive material remaining in a solid form in, and being substantially inert to, the slag with the slag for forming a slag-counter electrode interface; and
during electrorefining operations:
supplying an electromotive force between the electrode connection and the counter electrode so as to induce electrochemical reactions to occur at both the steel-slag interface and the slag-counter electrode interface; and
producing a molten steel depleted of the carbon impurities.

206. The method of claim 205, wherein a silicon by-product is recovered at the counter electrode during the refining operations.

207. An apparatus for performing the method according to claim 205 or 206, the apparatus being as defined in any one of claims 127 to 197.

208. The method of claims 1 to 81, wherein the impurities content is sensed or measured electrochemically.

209. The method of claim 1 or 2, wherein the impurities comprise copper.

210. The apparatus of claim 127, wherein the impurities comprise copper.
